(19) United States
(12) Patent Application Publication
(10) Pub. No.: US 2026/0361930 A1
(43) Pub. Date: Nov. 12, 2026

(54) INTERACTION METHOD AND APPARATUS BASED ON LIVE STREAM INTERFACE, ELECTRONIC DEVICE, COMPUTER-READABLE STORAGE MEDIUM, AND COMPUTER PROGRAM PRODUCT

(71) Applicant: Tencent Technology (Shenzhen) Company Limited, Shenzhen (CN)

(72) Inventors: Rongjun LI, Shenzhen (CN); Chen HE, Shenzhen (CN); Huayong LIANG, Shenzhen (CN)

(21) Appl. No.: 19/724,005

(22) Filed: Jun. 29, 2026

Related U.S. Application Data
(63) Continuation of application No. PCT/CN2025/084652, filed on Mar. 25, 2025.

(30) Foreign Application Priority Data
May 6, 2024 (CN) 202410552129.7

(51) Int. Cl. H04N 21/2187; H04N 21/431; H04N 21/466; H04N 21/475; H04N 21/4788

(52) U.S. Cl. CPC H04N 21/2187; H04N 21/4316; H04N 21/4668; H04N 21/4758; H04N 21/4788

(57) ABSTRACT

Disclosed is an interaction method and apparatus based on a live stream interface performed by an electronic device. The method includes: displaying a live stream interface in a first live stream room, the first live stream room including a first viewer account watching a live stream; displaying an interactive content transmission region and a content type option, the interactive content transmission region being configured for generating an interactive content published by the first viewer account in the first live stream room, and the content type option being configured for determining a content type of the interactive content; receiving a generation operation on a first interactive content in the interactive content transmission region, and receiving a configuration operation on a first content type for a first content type option; and displaying the first interactive content published by the first viewer account in a display mode corresponding to the first content type.

### CROSS-REFERENCE TO RELATED APPLICATIONS

This application is a continuation application of PCT Patent Application No. PCT/CN2025/084652, entitled “INTERACTION METHOD AND APPARATUS BASED ON LIVE STREAM INTERFACE, ELECTRONIC DEVICE, COMPUTER-READABLE STORAGE MEDIUM, AND COMPUTER PROGRAM PRODUCT” filed on Mar. 25, 2025, which claims priority to Chinese Patent Application No. 2024105521297, entitled “INTERACTION METHOD AND APPARATUS BASED ON LIVE STREAM INTERFACE, ELECTRONIC DEVICE, COMPUTER-READABLE STORAGE MEDIUM, AND COMPUTER PROGRAM PRODUCT” filed on May 6, 2024, both of which are incorporated herein by reference in their entirety.

### FIELD OF THE TECHNOLOGY

This application relates to the technical field of computers, and in particular, to an interaction method and apparatus based on a live stream interface, an electronic device, a computer-readable storage medium, and a computer program product.

### BACKGROUND OF THE DISCLOSURE

A live stream room is a type of network live stream program launched by an initiator over the Internet, through which a host and viewers can interact with one another.

In the related art, when viewers have questions about a live stream content in a live stream process, they generally transmit the questions in an interactive region of a live stream room, and a host gives feedback to the viewers according to the questions displayed in the interactive region, so that a question interaction process is achieved.

However, when the viewers transmit the questions to the host in the interactive region, due to a large number of messages in the interactive region, the host cannot perceive the questions in the interactive region. In consequence, interaction efficiency is low.

### SUMMARY

In view of the above, an interaction method and apparatus based on a live stream interface, an electronic device, a computer-readable storage medium, and a computer program product are provided in embodiments of this application to improve interaction efficiency. The technical solutions are provided below.

In an aspect, an interaction method based on a live stream interface is performed by an electronic device, and the method includes:

displaying a live stream interface in a first live stream room, the first live stream room including a viewer account watching a live stream, and the viewer account including a first viewer account master-controlled by the electronic device;

displaying, in the live stream interface, an interactive content transmission region and a content type option;

receiving a generation operation on a first interactive content in the interactive content transmission region and a configuration operation on a first content type for a first content type option; and

displaying, in the live stream interface, the first interactive content published by the first viewer account in a display mode corresponding to the first content type.

In another aspect, an interaction method based on a live stream interface is provided. The method is applied to an electronic device, and includes:

displaying a host interface in a first live stream room, the host interface being a display interface corresponding to a host account in the first live stream room, and the host account being an account master-controlled by the electronic device; and

displaying, in response to receiving a first interactive content published by a first viewer account in the first live stream room and determining that the first interactive content corresponds to a first content type, the first interactive content published by the first viewer account in a display mode corresponding to the first content type,

the first content type being a content type configured for the first interactive content when the first viewer account generates the first interactive content.

In yet another aspect, an electronic device is provided. The electronic device includes a processor and a memory, the memory having at least one instruction, at least one program, a code set, or an instruction set stored therein, the at least one instruction, the at least one program, the code set, or the instruction set being loaded and executed by the processor to implement the interaction method based on a live stream interface according to any one of the embodiments of this application.

In yet another aspect, a non-transitory computer-readable storage medium is provided. The storage medium has at least one instruction, at least one program, a code set, or an instruction set stored therein, the at least one instruction, the at least one program, the code set, or the instruction set being loaded and executed by a processor of a computer device to cause the computer device to implement the interaction method based on a live stream interface according to any one of the embodiments of this application.

The technical solutions according to the embodiments of this application have at least the beneficial effects as follows:

By receiving the configuration operation on the first content type for the first content type option, the viewer can autonomously configure the content type of the interactive content transmitted in the interactive content transmission region. On such a basis, the first interactive content published by the first viewer account is displayed in the display mode corresponding to the first content type, and thus a solution in which the display mode of the interactive content corresponds to the content type is achieved, and the host and the viewer can acquire the content type of the interactive content according to the display mode. Accordingly, when there is a large number of interactive contents, an interactive content of a specific content type can be highlighted. A specific display mode can assist the host in perceiving the interactive content of the specific content type in time, so that the host can give targeted feedback based on the interactive content in time, and interaction efficiency can be improved.

### BRIEF DESCRIPTION OF THE DRAWINGS

To describe the technical solutions in embodiments of this application more clearly, the accompanying drawings required for describing the embodiments are briefly described below. Clearly, the accompanying drawings in the following descriptions show merely some embodiments of this application, and those of ordinary skill in the art can still derive other accompanying drawings from these accompanying drawings without creative efforts.

FIG. 1 is a schematic diagram of an implementation environment according to an embodiment of this application.

FIG. 2 is a first flowchart of an interaction method based on a live stream interface according to an embodiment of this application.

FIG. 3 is a schematic diagram of a question interaction according to an embodiment of this application.

FIG. 4 is a second flowchart of an interaction method based on a live stream interface according to an embodiment of this application.

FIG. 5 is a third flowchart of an interaction method based on a live stream interface according to an embodiment of this application.

FIG. 6 is a fourth flowchart of an interaction method based on a live stream interface according to an embodiment of this application.

FIG. 7 is a schematic diagram of an association with a recommended content according to an embodiment of this application.

FIG. 8 is a fifth flowchart of an interaction method based on a live stream interface according to an embodiment of this application.

FIG. 9 is a schematic diagram of a feedback prompt according to an embodiment of this application.

FIG. 10 is a sixth flowchart of an interaction method based on a live stream interface according to an embodiment of this application.

FIG. 11 is a seventh flowchart of an interaction method based on a live stream interface according to an embodiment of this application.

FIG. 12 is a schematic diagram of a host interface according to an embodiment of this application.

FIG. 13 is a schematic diagram of an interaction based on a host interface according to an embodiment of this application.

FIG. 14 is a schematic diagram of an overall interaction flow based on a live stream interface according to an embodiment of this application.

FIG. 15 is a schematic diagram of an independent reply technical flow according to an embodiment of this application.

FIG. 16 is a schematic diagram of an interaction of a live stream comment module according to an embodiment of this application.

FIG. 17 is a first structural block diagram of an interaction apparatus based on a live stream interface according to an embodiment of this application.

FIG. 18 is a second structural block diagram of an interaction apparatus based on a live stream interface according to an embodiment of this application.

FIG. 19 is a structural block diagram of a terminal according to an embodiment of this application.

The above “first” and “second” are merely used to differentiate between different solutions instead of superiority or inferiority of the solutions or priorities in an implementation process.

### DESCRIPTION OF EMBODIMENTS

To make the objectives, technical solutions, and advantages of this application clearer, this application will be further described in detail with reference to the accompanying drawings below. The embodiments described are not to be deemed as limiting this application. All other embodiments derived by those of ordinary skill in the art without creative efforts fall within the scope of protection of this application.

In the following descriptions, “some embodiments” is involved to describe sub-sets of all possible embodiments. However, “some embodiments” can be the same sub-set or different sub-sets of all the possible embodiments, and can be combined with one another without conflict.

All technical and scientific terms used herein have the same meanings as those commonly understood by those skilled in the art belonging to this application, unless defined otherwise. The terms used herein are merely to describe the objectives in the embodiments of this application, and are not intended to limit this application.

Although the terms such as first and second are probably used in this application to describe various information, the information is not to be limited to these terms. These terms are merely used to differentiate between the same type of information. For example, without departing from the scope of this application, the first parameter can alternatively be referred to as the second parameter. Similarly, the second parameter can alternatively be referred to as the first parameter. Depending on the context, for example, the word “if” used herein can be interpreted as “while . . . ”, “when . . . ”, or “in response to determining”.

In the embodiments of this application, the term “module” or “unit” indicates a computer program with a predetermined function or a part of the computer program with the predetermined function, operates along with other related parts to achieve a predetermined target, and can be fully or partially implemented through software, hardware (such as a processing circuit and a memory), or their combination. Similarly, a processor (or a plurality of processors or memories) can be used to achieve one or more modules or units. In addition, each module or unit can be a part of an overall module or unit that has a function of the module or unit.

At least one described below indicates one or more, and “a plurality of” can indicate two or more, unless specified otherwise.

Before the embodiments of this application are further described in detail, nouns and terms involved in the embodiments of this application are described. The nouns and terms involved in the embodiments of this application are subject to the following explanations.
1) In response to: It is configured for denoting a condition or state on which performed operations depend. When the dependent condition or state is satisfied, one or more of the operations can be performed in real time or with a set delay. There is no limitation on the successive order in which a plurality of operations are performed, unless specified otherwise.
2) Human-computer interaction interface: It is an interface configured for providing a human-computer interaction function/presenting an interactive content in a live stream room.

For example, a graphical user interface (GUI) presents an augmented reality (AR) interface, a virtual reality (VR) interface, a voice user interface (VUI), an interactive projection interface (displaying information on a plane by using a projection technology), an eye movement detection interface (an interface controlled by detecting a line of sight of a user), a holographic interface (a three-dimensional hologram is formed by projecting an image through a holographic projection technology, and a perspective image can be seen without special glasses), a multi-modal interface (an interactive interface combining a plurality of interactive modes, such as touch, vision, and hearing), and a brain-machine interface (BMI).
3) Interactive content: It indicates information transmitted and received between a host account and a viewer account through an interaction function in a live stream process. The information can be in various forms such as text, voice, image, and video, and is configured for implementing real-time communication and interactions between the host and the viewer.
4) Content type: It indicates a category and property of an interactive content, and is configured for differentiating between different types of interactive information. According to different properties and uses of the interactive contents, the content types can be classified as follows:

Question type: The interactive content is a question content published by at least one of the host account and the viewer account in a first live stream room, and is configured for posing a question or seeking a reply for the host or another viewer.

Reply type: The interactive content is a reply content published by at least one of the host account and the viewer account for the question content in the first live stream room, and is configured for answering the question or giving a reply.

Positive comment type: The interactive content is a positive comment content published by the viewer account in the first live stream room for a live stream content, and is configured for expressing appreciation and approval of the live stream content.

Prize drawing type: The interactive content is a password content published by the viewer account in the first live stream room for participating in a prize drawing activity in the live stream room, and is configured for participating in the prize drawing activity and having the opportunity to win a prize.
5) Configuration operation: It is an operation that a user selects or sets the content type of the interactive content in an interactive content transmission region. Such an operation allows the user to specify the type into which the interactive content is classified, so as to affect display, processing, and management modes for the interactive content. The configuration operation can include a plurality of forms as follows:

Selection operation: The user selects one or more content types from a plurality of candidate content types. This is generally completed by clicking, touching, or hovering on a content type option, and selecting the content type option.

Check operation: When the content type option includes a check control, the user selects or deselects a content type by clicking or touching the check control. The check control generally exists in a form of a check box or a radio button.

Trigger operation: The user triggers (for example, clicks or touches) the content type option to display the plurality of candidate content types. Then, the user selects a needed content type from the displayed options.

Editing operation: In some cases, the user probably needs to edit or customize the content type, which involves inputting a name of a new content type or modifying an attribute of an existing content type.
6) Deselected state: It indicates a state in which a check control of the content type option is not selected in the interactive content transmission region, showing that a specific content type is not selected currently. In such a state, the interactive content generated and transmitted by the user in the interactive content transmission region is automatically classified into a preset default content type. The default content type is generally preset by a system, and is configured for processing interactive contents having no explicitly-specified content type.
7) Feedback prompt information: It indicates information displayed on a terminal of a first viewer account when the host account transmits a feedback content for a first interactive content of the viewer account during a live stream interaction, and is configured for prompting the viewer account to view the feedback content of the host account. The feedback prompt information can have different forms to adapt to different feedback modes and different viewer demand.

The type of the feedback prompt information includes, but is not limited to, at least one of the following:

Public reply prompt information: Such prompt information indicates that the host account replies to the first interactive content in a public interactive content display region. Generally, the public reply can be seen by all viewers. Thus, such prompt information can make the first viewer account realize that the interactive content of the first viewer account has received the public response from the host.

Independent reply prompt information: Such prompt information indicates that the host account replies to the first interactive content through a private chat dialog box with the first viewer account. The independent reply is private, and can be seen only by the first viewer account and the host account. Thus, such prompt information prompts the first viewer account to view a feedback content in a private chat.

Explanation reply prompt information: Such prompt information indicates that the host account replies to the first interactive content through a live stream image representation (such as a voice explanation, a gesture, and an expression). The explanation reply is delivered through a live stream image. Thus, such prompt information prompts the first viewer account to watch the live stream image to obtain a feedback content.
8) Same-question operation: It indicates an operation performed by the viewer account on a published interactive content (especially, the question content) during the live stream interaction, showing that the viewer account also wants to pose the same question or express the same opinion.

A live stream room is a type of network live stream program launched by an initiator over the Internet, through which a host and viewers can interact with one another. In the related art, when viewers have questions about a live stream content in a live stream process, they generally transmit the questions in an interactive region of a live stream room, and a host gives feedback to the viewers according to the questions displayed in the interactive region, so that a question interaction process is achieved. However, when the viewers transmit the questions to the host in the interactive region, due to a large number of messages in the interactive region, the host cannot perceive the questions in the interactive region. In consequence, interaction efficiency is low.

In an interaction method based on a live stream interface according to the embodiments of this application, by receiving a configuration operation on a first content type for a first content type option, a viewer can autonomously configure a content type of an interactive content transmitted in an interactive content transmission region. On such a basis, a first interactive content published by a first viewer account is displayed in a display mode corresponding to the first content type, and thus a solution in which the display mode of the interactive content corresponds to the content type is achieved, and a host and the viewer can acquire the content type of the interactive content according to the display mode. Accordingly, when there is a large number of interactive contents, an interactive content of a specific content type can be highlighted. A specific display mode can assist the host in perceiving the interactive content of the specific content type in time, so that the host can give targeted feedback based on the interactive content in time, and interaction efficiency can be improved.

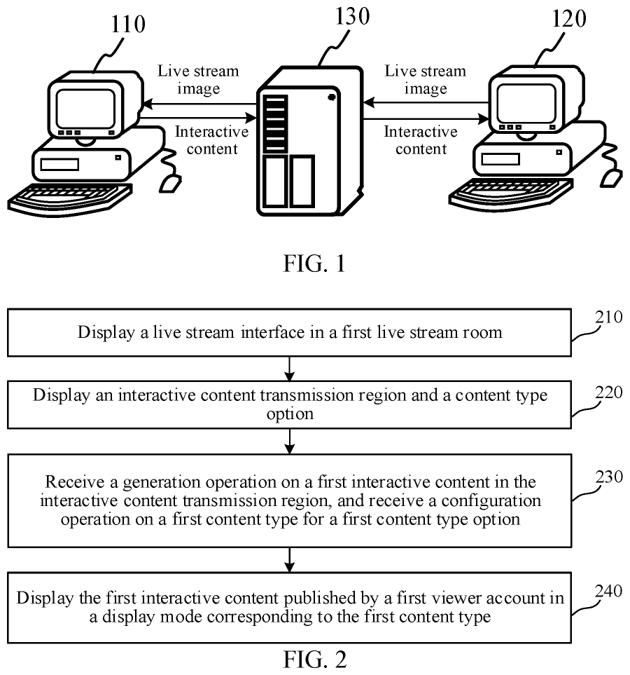

An implementation environment of this application is described first. With reference to FIG. 1, a schematic diagram of an implementation environment according to an embodiment of this application is shown in FIG. 1. The implementation environment includes a terminal 110, a terminal 120, and a server 130.

The description is made with a terminal of a viewer account as the terminal 110 and a terminal of a host account as the terminal 120 as an example. The host account master-controlled by the terminal 120 is configured for activating a first live stream room. The viewer account master-controlled by the terminal 110 may enter the first live stream room to watch a live stream content. The server 130 is a live stream backend server, and is configured to provide a backend service based on a live stream application.

Illustratively, the terminal 110 displays a live stream interface in the first live stream room through a human-computer interaction interface of the terminal 110. The first live stream room includes a viewer account watching a live stream, and the viewer account includes a first viewer account master-controlled by the current terminal 110. An interactive content transmission region and a content type option are displayed. The interactive content transmission region is configured for generating an interactive content published by the first viewer account in the first live stream room, and the content type option is configured for determining a content type of the interactive content. A generation operation on a first interactive content in the interactive content transmission region is received, and a configuration operation on a first content type is received for a first content type option. The first interactive content published by the first viewer account is displayed in a display mode corresponding to the first content type.

The terminal 120 displays a host interface in the first live stream room through a human-computer interaction interface of the terminal 120. The host interface is a display interface corresponding to the host account in the first live stream room, and the host account is an account master-controlled by the current terminal 120. In response to receiving the first interactive content published by the first viewer account in the first live stream room and determining that the first interactive content corresponds to the first content type, the first interactive content published by the first viewer account is displayed in the display mode corresponding to the first content type. The first content type is a content type configured for the first interactive content when the first viewer account generates the first interactive content.

In some embodiments, the server 130 is configured to forward a live data stream between the terminal 110 and the terminal 120.

Illustratively, the server 130 is configured to receive a live stream image published by the terminal 120, and forward the live stream image to the terminal 110 for display in a live stream process. The server 130 receives the first interactive content published by the terminal 110 in the first live stream room, and forwards the first interactive content to the terminal 120 for display.

The above communication interaction among the server 130, the terminal 110, and the terminal 120 is merely illustrative, and is not limited in this application.

The terminal is exemplary. The terminal may be a terminal device in a plurality of forms, such as a desktop computer, a portable laptop computer, a mobile phone, a tablet computer, an e-book reader, a moving picture experts group audio layer III (MP3) player, a moving picture experts group audio layer IV (MP4) player, a smart television, and a smart in-vehicle device, which is not limited in the embodiments of this application.

The server may be an independent physical server, or may be a server cluster or a distributed system formed by a plurality of physical servers, or may be a cloud server that provides basic cloud computing services such as a cloud service, cloud security, a cloud database, cloud computing, a cloud function, cloud storage, a network service, cloud communication, a middleware service, a domain name service, a security service, a content delivery network (CDN), big data, and an artificial intelligence platform.

The cloud technology is a type of hosting technology that unifies a series of resources such as hardware, software, and networks in a wide area network or a local area network, to implement computing, storing, processing, and sharing of data.

In some embodiments, the server may alternatively be implemented as a node in a blockchain system.

The information (including, but not limited to, user equipment information, user personal information, etc.), data (including, but not limited to, data for analysis, stored data, presented data, etc.), and signals involved in the embodiments of this application are authorized by a user or fully authorized by each party, and the collection, use, and processing of relevant data need to comply with relevant laws and regulations of relevant regions. For example, operation data, account information, etc. involved in the embodiments of this application are acquired under full authorization.

In some embodiments, before user-related data (for example, the account information, historical operation data, and real-time operation data involved in this application) are collected and in a process of collecting the user-related data in the embodiments of this application, a prompt interface or a pop-up window may be displayed, or voice prompt information may be outputted. The prompt interface, the pop-up window, or the voice prompt information is configured for prompting the user that data related to the user are currently collected. Thus, in the embodiments of this application, related operations of acquiring the user-related data are performed only after a confirmation operation by the user for the prompt interface or the pop-up window is acquired. Otherwise (to be specific, when no confirmation operation by the user for the prompt interface or the pop-up window is acquired), the related operations of acquiring the user-related data are ended, and to be specific, no user-related data are acquired. In other words, all user data collected in the embodiments of this application are collected with user consent and authorization, and the collection, use, and processing of the related user data need to comply with relevant laws, regulations, and standards of relevant regions.

Illustratively, with reference to FIG. 2, a first flowchart of an interaction method based on a live stream interface according to an embodiment of this application is shown in FIG. 2. The method may be performed by the terminal or the server, or may be jointly performed by the terminal and the server simultaneously. The embodiment of this application is described with the method performed by the terminal as an example. As shown in FIG. 2, the method includes the following operations:

Operation 210: Display a live stream interface in a first live stream room.

The first live stream room includes a viewer account watching a live stream, and the viewer account includes a first viewer account master-controlled by a current terminal.

The first live stream room indicates a virtual room created by a host account in a live stream application, and is a type of network live stream program configured for a real-time live stream interaction.

In some embodiments, the first live stream room is configured for presenting a live stream interface of the host account. For a terminal of the host account, the first live stream room performs live stream presentation based on operation control by a host, and receives an interactive operation by the host account. For a terminal of the viewer account, the first live stream room is configured for presenting the live stream interface, and receiving an interactive operation by the viewer account. The embodiment of this application is described with the terminal of the viewer account as an example. The first viewer account of the viewer account is master-controlled by the current terminal in the first live stream room.

In some embodiments, the first live stream room further includes an assistant account. The assistant account is a user account assisting the host account in the live stream. The assistant account and the host account jointly manage the first live stream room. The assistant account is an administrative account authorized by the host account. The embodiment of this application is described with the administrative account implemented as the host account as an example.

In some embodiments, the first live stream room may be a live stream room in any form, such as a virtual game live stream room, a real-person performance live stream room, an online variety live stream room, an online sales live stream room, and an online teaching live stream room, which is not limited in the embodiments of this application.

The live stream interface in the first live stream room may include a live stream image region, and may further include an interactive content display region. The live stream image region is configured for displaying the live stream image presented by the host account to the viewer account. The interactive content display region is configured for displaying an interactive content published by at least one of the host account and the viewer account in the first live stream room.

In some embodiments, the interactive content display region may be an independent region isolated from the live stream image region in the live stream interface, or may be an overlapping region superposed on the live stream image. A region division relationship between the live stream image region and the interactive content display region in the live stream interface is not limited in the embodiments of this application.

In some embodiments, the interactive content may be a comment content, a question content, etc. published by the viewer account in the first live stream room, or may be a notification content, a feedback content, etc. published by the host account in the first live stream room.

Illustratively, the embodiment of this application is described with the interactive content implemented as a bullet-screen comment content in the live stream room as an example. The first live stream room may display the bullet-screen comment content based on an interactive operation by a user account. The user account may be the host account or the viewer account. The interactive operation indicates an operation performed by the user account in the first live stream room.

In some embodiments, the bullet-screen comment content (the interactive content) includes at least one of a machine bullet-screen comment, a text bullet-screen comment, a gift bullet-screen comment, and an interactive bullet-screen comment. The machine bullet-screen comment is a bullet-screen comment automatically generated by the backend server based on interactive data of the user account in the first live stream room, and delivered to the terminal of the corresponding account. The interactive data include, but are not limited to, at least one of dwell duration of the user account in the first live stream room, a type of the interactive operation performed by the user account, current account information of the user account, and real-time operation data of the user account. The text bullet-screen comment is a bullet-screen comment configured for publishing a text interactive content. The gift bullet-screen comment is configured for presenting a virtual gift given to the first live stream room by the user account. The interactive bullet-screen comment indicates a bullet-screen comment configured for receiving a preset interactive operation.

A representation form (for example, the bullet-screen comment content) of the interactive content and a type of the bullet-screen comment content are merely illustrative, and are not limited in the embodiments of this application.

Operation 220: Display the interactive content transmission region and a content type option.

The interactive content transmission region is configured for generating an interactive content published by the first viewer account in the first live stream room, and the content type option is configured for determining a content type of the interactive content.

In some embodiments, the content type of the interactive content includes, but is not limited to, at least one of a question type, a reply type, a positive comment type, a prize drawing type, etc.

The question type is configured for indicating that the interactive content is a question content published by at least one of the host account and the viewer account in the first live stream room. The reply type is configured for indicating that the interactive content is a reply content published by at least one of the host account and the viewer account for the question content in the first live stream room. For example, the first viewer account publishes the question content belonging to the question type in the first live stream room, and a reply content published by the host account or another viewer account based on the question content belongs to the reply type. The positive comment type is configured for indicating that the interactive content is a positive comment content published by the viewer account in the first live stream room for the live stream content. The prize drawing type is configured for indicating that the interactive content is a password content published by the viewer account in the first live stream room, and is configured for participating in a prize drawing activity in the live stream room.

The content type of the interactive content is merely illustrative, and is not limited in the embodiments of this application.

The interactive content transmission region may be implemented as at least one of content transmission regions such as a text input region, a voice input region, a multimedia editing region, and a shortcut transmission region.

The text input region is configured for receiving a text content edited through a text input operation, and taking the text content as the interactive content. The voice input region is configured for receiving a voice segment inputted by the user, and taking the voice segment as the interactive content, or configured for converting a voice segment into a text content, and taking the text content as the interactive content. The multimedia editing region is configured for receiving an editing operation on a multimedia resource such as an image and a video clip, and taking an edited multimedia resource as the interactive content. The shortcut transmission region is configured for receiving a selection operation, and selecting an interactive content to be published in the first live stream room from a plurality of preset interactive contents (such as an emoji and a preset statement).

The representation form of the interactive content transmission region and an interactive content generation mode are merely illustrative, and are not limited in the embodiments of this application.

In some embodiments, the content type option is configured for triggering display of a plurality of candidate content types. By receiving a selection operation on a first content type of the plurality of candidate content types, it is determined that the interactive content corresponds to the first content type. Alternatively, the content type option includes a check control corresponding to a first content type. By receiving a trigger operation on the check control, it is determined that the interactive content corresponds to the first content type.

Operation 230: Receive a generation operation on a first interactive content in the interactive content transmission region, and receive a configuration operation on the first content type for a first content type option.

The first interactive content may be an interactive content in any form, such as a text content, an image content, and a voice content.

In some embodiments, the generation operation on the first interactive content may be at least one of content generation operations such as an editing operation or a selection operation on the text content; an authoring operation, a selection operation, or an editing operation on the image content; and an input operation on the voice content.

The configuration operation on the first content type may be a selection operation on the first content type from the plurality of candidate content types, or a check operation on the first content type when the first content type corresponds to the check control.

Illustratively, the content type option includes the check control corresponding to the first content type, and receiving the configuration operation may be implemented as receiving the selection operation on the check control corresponding to the first content type. The selection operation is configured for switching the first content type from a deselected state to a selected state.

Illustratively, the interactive content may correspond to a plurality of candidate content types. Receiving the configuration operation may be implemented as receiving a trigger operation on the content type option, displaying the plurality of candidate content types, the plurality of candidate content types including the first content type, and receiving a selection operation on the first content type.

In some embodiments, the first content type corresponding to the first interactive content may alternatively be automatically determined according to the first interactive content generated in the interactive content transmission region.

In some embodiments, With the content type option including the check control corresponding to the first content type as an example, automatically determining the content type may be implemented as displaying, in response to determining that the first interactive content generated in the interactive content transmission region includes at least one of a specified symbol and a specified text content, an automatic switch of the check control corresponding to the first content type from a deselected state to a selected state.

Illustratively, in response to determining that the first interactive content generated in the interactive content transmission region includes at least one of the specified symbol “?” and the specified text contents “why”, “how”, “whether”, and “how much”, it is determined that the first interactive content corresponds to the question type, and an automatic switch of a check control corresponding to the question type from a deselected state to a selected state is displayed.

In some embodiments, in response to an editing operation on the first interactive content in the interactive content transmission region, the first content type corresponding to the first interactive content is automatically identified through a pretrained machine learning model.

Illustratively, the machine learning model may be any one of the following: Naive Bayes, Support Vector Machines (SVM), k-Nearest Neighbors (k-NN), Decision Trees, Convolutional Neural Networks (CNN), and Random Forest. The machine learning model may be trained by performing the following processing of acquiring an initialized machine learning model; acquiring an interactive content sample and a real tag, the real tag denoting a real content type of the interactive content sample; invoking the initialized machine learning model based on the interactive content sample, and obtaining a predicted tag, the predicted tag denoting a predicted content type of the interactive content sample; and determining a loss based on the real tag and the predicted tag, updating parameters of the initialized machine learning model based on the loss, and obtaining the pretrained machine learning model.

Initialization indicates that random values are assigned to the parameters of the machine learning model. For example, 0 or 1 is assigned to all the parameters of the machine learning model. A convolutional layer and a fully connected layer of the initialized machine learning model are invoked based on the interactive content sample, and the predicted tag is obtained. A loss between the real tag and the predicted tag is calculated according to a loss function, and back propagation is performed on the loss to update the parameters of the initialized machine learning model. A process of calculating the loss and updating the parameters is iterated repeatedly, an iteration process is not stopped until the loss converges, and the pretrained machine learning model is formed. The loss function may be any one of a mean square error loss function, a cross entropy loss function, a multi-tag classification loss function, and a triplet loss function. The back propagation is implemented according to a back propagation algorithm. A gradient of each neuron is computed from an output layer to an input layer, a weight and a bias of the neuron are updated according to the gradient, and parameters are continuously updated in a gradient descent mode, so that the loss is lowered. The gradient descent may employ various gradient descent algorithms, such as a batch gradient descent algorithm, a stochastic gradient descent algorithm, an adaptive gradient descent algorithm, and a momentum gradient descent algorithm.

According to the embodiments of this application, the content type is automatically identified, so that manual intervention can be reduced, and a content classification speed can be increased. Especially when a large number of interactive contents are processed, work efficiency can be improved. The machine learning model can maintain consistent classification standards after training, avoiding subjectivity and inconsistency that are probably caused by manual classification. A fully-trained machine learning model can learn complex patterns and features, so that classification accuracy can be improved.

Operation 240: Display the first interactive content published by the first viewer account in a display mode corresponding to the first content type.

The display mode corresponding to the first content type is different from display modes corresponding to other content types.

In some embodiments, the first interactive content may be displayed in a preset interactive content display region, or the first interactive content may be superposed on the live stream interface for display. A display location of the first interactive content is not limited in the embodiments of this application.

In some embodiments, a visual saliency of the first interactive content displayed in the display mode corresponding to the first content type is superior to visual saliency of interactive contents corresponding to other content types.

The first interactive content corresponding to the first content type may be explicitly indicated through the display mode corresponding to the first content type.

In some embodiments, the first interactive content published by the first viewer account is displayed in the interactive content display region. The first interactive content is marked with a first type tag corresponding to the first content type.

Illustratively, a first question content published by the first viewer account is displayed in a public comment region corresponding to the first live stream room. The first question content is marked with a question tag corresponding to the question type. For example, when the first interactive content (i.e. the first question content) is “what size is this shirt?”, the question type is taken as the type of the first interactive content. The question tag is displayed at the tail of the first interactive content, or the question tag may be displayed at the top, the head, or the lower right corner of the first interactive content. The position of the question tag is not limited herein.

In some embodiments, the first interactive content published by the first viewer account is displayed in the interactive content display region in a high-brightness display mode corresponding to the first content type.

In some embodiments, the high-brightness display mode includes at least one of the following display modes.

A first display mode: The first interactive content is displayed in the interactive content display region in a high-brightness mode through at least one of a background color and a text color that correspond to the first content type.

Illustratively, the interactive content is displayed in the interactive content display region through a background color with transparency of 100% and a first text color by default. When the first interactive content corresponds to the first content type, the first interactive content is displayed in the interactive content display region in a high-brightness mode through a second text color. A color contrast ratio of the second text color to the background color of the interactive content display region is higher than that of the first text color to the background color.

A second display mode: The first interactive content decorated with a first bounding box is displayed in the interactive content display region. Display configuration data corresponding to the first bounding box correspond to the first content type, and the display configuration data are configured for indicating at least one of a color, a size, brightness, a decorative element, and a shape that correspond to the first bounding box.

Illustratively, the interactive content is displayed in the interactive content display region in a borderless form by default. When the first interactive content corresponds to the question type, the first interactive content decorated with the first bounding box is displayed in the interactive content display region, and the first bounding box is decorated with a question mark element.

A third display mode: The first interactive content is displayed in the interactive content display region in an enlarged mode.

Illustratively, with the text content as an example, the interactive content is displayed in the interactive content display region in a first font size by default. When corresponding to the first content type, the first interactive content is displayed in a second font size. The second font size is greater than the first font size.

A fourth display mode: The first interactive content is kept displayed in a specified region of the interactive content display region according to preset duration.

Illustratively, a plurality of interactive contents are slidably displayed in the interactive content display region in sequence at a preset speed by default. When corresponding to the first content type, the first interactive content is kept displayed in a top region of the interactive content display region for 5 seconds. The preset duration may be customized or may be any default duration in the backend, which is not limited herein.

A fifth display mode: The first interactive content is displayed in the interactive content display region according to a preset animation special effect.

Illustratively, the interactive content is displayed in the interactive content display region in a display mode without an animation special effect by default. When the first interactive content corresponds to the first content type (with the positive comment type as an example), in a process of displaying the first interactive content in the interactive content display region, a preset like special effect is displayed around the first interactive content.

The above display modes are merely illustrative, and are not limited in the embodiments of this application.

In some embodiments, the first live stream room includes at least one recommended content. At least one recommended content includes a first recommended content. When the first interactive content published by the first viewer account is displayed, recommended information corresponding to the first recommended content may alternatively be displayed in association with the first interactive content.

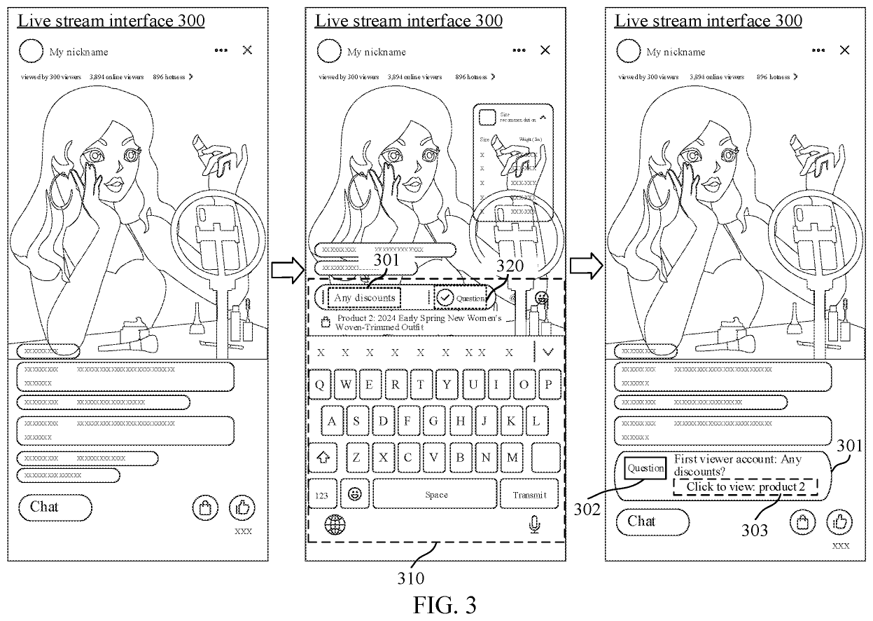

Illustratively, with reference to FIG. 3, a schematic diagram of a question interaction according to an exemplary embodiment of this application is shown in FIG. 3. As shown in FIG. 3, a live stream interface 300 in a first live stream room is displayed, an interactive content transmission region 310 and a content type option 320 are displayed, a generation operation on a first interactive content 301 in the interactive content transmission region 310 is received, a configuration operation on a question type is received for a first content type option 320, and the first interactive content 301 published by a first viewer account is displayed in a display mode corresponding to the question type. The first interactive content 301 is marked with a question tag 302. The first interactive content 301 is a question content published by the first viewer account for a first recommended content in the first live stream room. Recommended information 303 of the first recommended content is displayed in association with the first interactive content 301.

In conclusion, in the interaction method based on a live stream interface according to the embodiments of this application, by receiving the configuration operation on the first content type for the first content type option, the viewer can autonomously configure the content type of the interactive content transmitted in the interactive content transmission region. On such a basis, the first interactive content published by the first viewer account is displayed in the display mode corresponding to the first content type, and thus a solution in which the display mode of the interactive content corresponds to the content type is achieved, and the host and the viewer can acquire the content type of the interactive content according to the display mode of the interactive content. Accordingly, when there is a large number of interactive contents, an interactive content of a specific content type can be highlighted. A specific display mode can assist the host in perceiving the interactive content of the specific content type in time, so that the host can give targeted feedback based on the interactive content in time, and interaction efficiency can be improved.

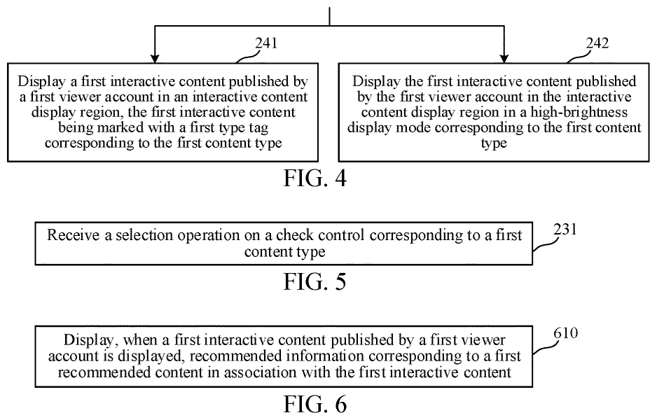

In some embodiments, the first interactive content corresponding to the first content type may be displayed in a plurality of display modes. With reference to FIG. 4, a second flowchart of an interaction method based on a live stream interface according to an embodiment of this application is shown in FIG. 4. The method may be performed by the terminal or the server, or may be jointly performed by the terminal and the server simultaneously. The embodiment of this application is described with the method performed by the terminal as an example. As shown in FIG. 4, operation 240 includes the following operations:

Operation 241: Display the first interactive content published by the first viewer account in the interactive content display region, the first interactive content being marked with a first type tag corresponding to the first content type.

The first type tag may be a text tag corresponding to the first content type, an icon tag corresponding to the first content type, or a voice tag corresponding to the first content type. The embodiment of this application is described with the question tag corresponding to the question type as an example.

Illustratively, the question tag may be implemented as a question text tag. When the question interactive content is displayed, the question text tag configured for marking the question interactive content is displayed. The question text tag includes a text content “question” corresponding to a content type name, and is configured for indicating that the interactive content belongs to the question type.

Illustratively, the question tag may be implemented as a question icon label. When the question interactive content is displayed, the question icon tag configured for marking the question interactive content is displayed. The question icon tag includes a question mark icon corresponding to a preset question symbol “?”, and is configured for indicating that the interactive content belongs to the question type.

Illustratively, the question tag may be implemented as a question voice tag. When the question interactive content is displayed, the question voice tag configured for marking the question interactive content is displayed. The question voice tag may automatically trigger playback of a voice content “there is a question awaiting for your reply”, and is configured for indicating that the interactive content belongs to the question type.

The content type and the representation form that correspond to the first type tag are merely illustratively, and are not limited in the embodiments of this application.

Operation 242: Display the first interactive content published by the first viewer account in the interactive content display region in a high-brightness display mode corresponding to the first content type.

The high-brightness display mode corresponding to the first content type is different from display modes of other interactive contents. In some embodiments, the visual saliency of the high-brightness display mode corresponding to the first content type is superior to the visual saliency of other interactive contents.

The visual saliency includes a display size, display brightness, color vividness, a visual difference from other display contents than the first interactive content, etc.

In some embodiments, the high-brightness display mode includes at least one of the following display modes.

A first display mode: The first interactive content is displayed in the interactive content display region in a high-brightness mode through at least one of a background color and a text color that correspond to the first content type.

Illustratively, the interactive content is displayed in the interactive content display region through a background color with transparency of 100% and a first text color by default. When the first interactive content corresponds to the first content type, the first interactive content is displayed in the interactive content display region in a high-brightness mode through a second text color. A color contrast ratio of the second text color to the background color of the interactive content display region is higher than that of the first text color to the background color.

Displaying the first interactive content in the high-brightness mode through at least one of the specific background color and the specific text color can intuitively improve the visual saliency of the first interactive content based on the color of the interactive content, and thus a capability of the host to perceive the first interactive content is improved.

A second display mode: The first interactive content decorated with a first bounding box is displayed in the interactive content display region. Display configuration data corresponding to the first bounding box correspond to the first content type, and the display configuration data are configured for indicating at least one of a color, a size, brightness, a decorative element, and a shape that correspond to the first bounding box.

Illustratively, the interactive content is displayed in the interactive content display region in a borderless form by default. When the first interactive content corresponds to the question type, the first interactive content decorated with the first bounding box is displayed in the interactive content display region, and the first bounding box is decorated with a question mark element.

The first interactive content is decorated with the first bounding box to add an additional decorative element to the first interactive content. Thus, the display mode of the first interactive content is different from display modes of other interactive contents, and the first interactive content is highlighted.

A third display mode: The first interactive content is displayed in the interactive content display region in an enlarged mode.

Illustratively, with the text content as an example, the interactive content is displayed in the interactive content display region in a first font size by default. When corresponding to the first content type, the first interactive content is displayed in a second font size. The second font size is greater than the first font size.

By displaying the first interactive content in the enlarged mode, the first interactive content is visually highlighted, so that the host can still notice the first interactive content in a case of a large number of interactive contents.

A fourth display mode: The first interactive content is kept displayed in a specified region of the interactive content display region according to preset duration.

Illustratively, a plurality of interactive contents are slidably displayed in the interactive content display region in sequence at a preset speed by default. When corresponding to the first content type, the first interactive content is kept displayed in a top region of the interactive content display region for 5 seconds.

By prolonging the display keeping duration of the first interactive content, the first interactive content is prevented from rapidly disappearing in the interactive content display region, and the possibility that the host perceives the first interactive content is increased.

A fifth display mode: The first interactive content is displayed in the interactive content display region according to a preset animation special effect.

Illustratively, the interactive content is displayed in the interactive content display region in a display mode without an animation special effect by default. When the first interactive content corresponds to the first content type (with the positive comment type as an example), in a process of displaying the first interactive content in the interactive content display region, a preset like special effect is displayed around the first interactive content. When the first interactive content corresponds to the first content type (with the question type as an example), in a process of displaying the first interactive content in the interactive content display region, a preset question mark special effect is displayed around the first interactive content. When the first interactive content corresponds to the first content type (with the prize drawing type as an example), in a process of displaying the first interactive content in the interactive content display region, a rotary prize ticket or a flickering prize drawing symbol is displayed around the first interactive content. When the first interactive content corresponds to the first content type (with the notification type as an example), in a process of displaying the first interactive content in the interactive content display region, a flickering exclamation mark or a bubble is displayed around the first interactive content.

By adding the animation special effect, a dynamic display effect of the first interactive content is enriched, and the visual saliency of the first interactive content is improved.

The above display modes are merely illustrative, and are not limited in the embodiments of this application.

Operation 241 and operation 242 are two parallel display solutions. In some embodiments, in an interaction process based on the live stream interface, one of operation 241 and operation 242 may be selected to be performed, or operation 241 and operation 242 may be performed simultaneously, which is not limited in the embodiments of this application.

Illustratively, operation 240 may be implemented as displaying the first interactive content published by the first viewer account in the interactive content display region in the high-brightness display mode corresponding to the first content type. The first interactive content is marked with the first type tag corresponding to the first content type.

In conclusion, in the interaction method based on a live stream interface according to the embodiments of this application, a plurality of display modes corresponding to the first content type are provided, so that a display solution of the first interactive content is enriched, the association between the display mode of the first interactive content and the first content type is strengthened, and the host and the viewer can directly acquire the content type of the interactive content according to the display mode of the interactive content. Accordingly, when there is a large number of interactive contents, an interactive content of a specific content type can be highlighted. A specific display mode can assist the host in perceiving the interactive content of the specific content type in time, so that the host can give targeted feedback based on the interactive content in time, and interaction efficiency can be improved.

In some embodiments, the content type option includes a check control corresponding to the first content type. With reference to FIG. 5, a third flowchart of an interaction method based on a live stream interface according to an embodiment of this application is shown in FIG. 5. The method may be performed by the terminal or the server, or may be jointly performed by the terminal and the server simultaneously. The embodiment of this application is described with the method performed by the terminal as an example. As shown in FIG. 5, operation 230: receive a configuration operation on the first content type may include the following operations:

Operation 231: Receive a selection operation on a check control corresponding to the first content type.

The selection operation is configured for switching the first content type from a deselected state to a selected state.

The deselected state is configured for indicating that the first content type is not selected currently, and the interactive content generated and transmitted in the interactive content transmission region belongs to a preset default content type.

The selected state is configured for indicating that the first content type is selected currently, and the interactive content generated and transmitted in the interactive content transmission region belongs to the first content type.

Illustratively, after the first viewer account enters the first live stream room, the deselected state of the check control corresponding to the first content type is displayed by default. In response to receiving the selection operation on the check control corresponding to the first content type, the first content type is switched from the deselected state to the selected state. On such a basis, the interactive content generated and transmitted in the interactive content transmission region belongs to the first content type.

In some embodiments, the content type corresponding to the first interactive content may alternatively be determined by automatically inspecting the first interactive content.

In some embodiments, in response to determining that the first interactive content generated in the interactive content transmission region includes a specified symbol, an automatic switch of the check control corresponding to the first content type from the deselected state to the selected state is displayed; or in response to determining that the first interactive content generated in the interactive content transmission region includes a specified text content, an automatic switch of the check control corresponding to the first content type from the deselected state to the selected state is displayed.

Illustratively, in response to determining that the first interactive content generated in the interactive content transmission region includes at least one of the specified contents including a specified symbol “?” and specified text contents “why”, “how”, “whether”, and “how much”, it is determined that the first interactive content corresponds to the question type, and an automatic switch of the check control corresponding to the question type from a deselected state to a selected state is displayed.

In some embodiments, the content type corresponding to the first interactive content is automatically identified through a pretrained content inspection model. When the first viewer account generates the first interactive content in the interactive content transmission region, the content inspection model automatically inspects the first interactive content. In response to determining that the first interactive content includes at least one of the specified symbol and the specified text content, it is determined that the first interactive content corresponds to the first content type.

In some embodiments, before the content type is automatically identified through the content inspection model, a process of training the content inspection model is further included. A sample interactive content is acquired, the sample interactive content being marked with a reference type tag. A sample content type corresponding to the sample interactive content is automatically inspected through a candidate content inspection model. A prediction loss value is determined based on a difference between the sample content type and the reference type tag. The candidate content inspection model is trained based on the prediction loss value until a preset training requirement is satisfied, and a trained content inspection model is obtained.

In the embodiments of this application, the interactive content is analyzed in real time through the content inspection model. Thus, the content type of the interactive content is rapidly determined, and it is ensured that the interactive content can be presented and processed in time. An automatic classification process can reduce manual intervention, accelerate classification of the interactive content, and improve work efficiency when a large number of interactive contents are processed. The content inspection model can maintain consistent classification standards after training, avoiding subjectivity and inconsistency that are probably caused by manual classification. Complex patterns and features can be learned after fully-trained content inspection, so that classification accuracy can be improved.

In some embodiments, a plurality of candidate content types are preset. Operation 230: Receive a configuration operation on the first content type may include the following operations:

Operation 1: Receive a trigger operation on the content type option, and display the plurality of candidate content types.

The plurality of candidate content types include the first content type.

In some embodiments, the plurality of candidate content types include, but are not limited to, at least one of a question type, a reply type, a positive comment type, a prize drawing type, etc.

The question type is configured for indicating that the interactive content is a question content published by at least one of the host account and the viewer account in the first live stream room. The reply type is configured for indicating that the interactive content is a reply content published by at least one of the host account and the viewer account for the question content in the first live stream room. For example, the first viewer account publishes the question content belonging to the question type in the first live stream room, and the reply content published by the host account or another viewer account based on the question content belongs to the reply type. The positive comment type is configured for indicating that the interactive content is a positive comment content published by the viewer account in the first live stream room for the live stream content. The prize drawing type is configured for indicating that the interactive content is a password content published by the viewer account in the first live stream room, and is configured for participating in a prize drawing activity in the live stream room.

Operation 2: Receive a selection operation on the first content type.

Illustratively, with the first content type being the question type as an example, a selection operation on the question type is received, and the first content type corresponding to the first interactive content is determined as the question type.

In conclusion, in the interaction method based on a live stream interface according to the embodiments of this application, the configuration operation on the first content type is provided, and an implementation basis is provided for the viewer account to autonomously configure the content type of the interactive content transmitted in the interactive content transmission region, so that interaction efficiency can be improved.

In some embodiments, the viewer account may further publish an interactive content associated with a recommended content in the live stream room. With reference to FIG. 6, a fourth flowchart of an interaction method based on a live stream interface according to an embodiment of this application is shown in FIG. 6. The method may be performed by the terminal or the server, or may be jointly performed by the terminal and the server simultaneously. The embodiment of this application is described with the method performed by the terminal as an example. As shown in FIG. 6, the method includes the following operations:

Operation 610: Display, when a first interactive content published by a first viewer account is displayed, recommended information corresponding to a first recommended content in association with the first interactive content.

The first live stream room includes at least one recommended content, and at least one recommended content includes the first recommended content.

The at least one recommended content is a content resource recommended by a host account to a viewer account in the first live stream room. The at least one recommended content may be a content resource in any form provided in the first live stream room, such as a picture, a video, audio, and text. The embodiment of this application is described with the recommended content being a sales content recommended in the first live stream room as an example.

In some embodiments, the first recommended content is a primarily-recommended content at a current moment set by the host account in the first live stream room; or the first recommended content is a recommended content associated with the first interactive content and selected by the first viewer account from at least one recommended content.

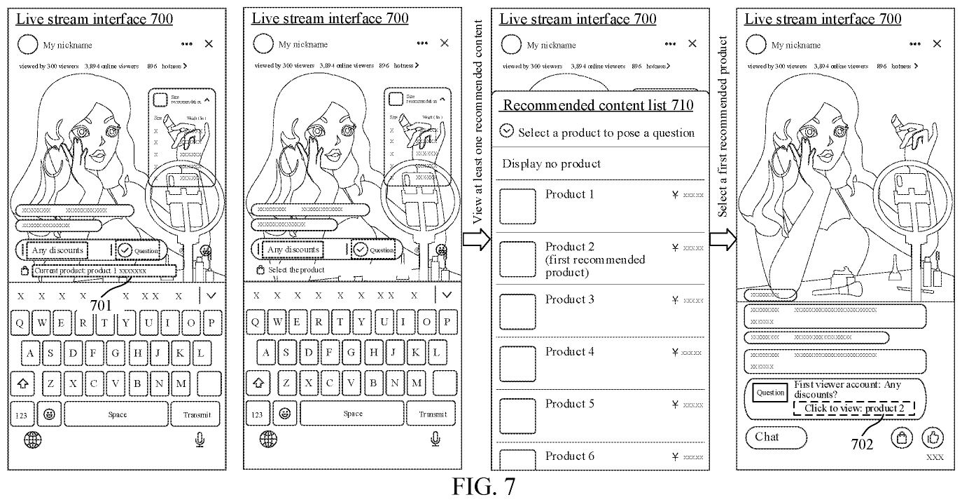

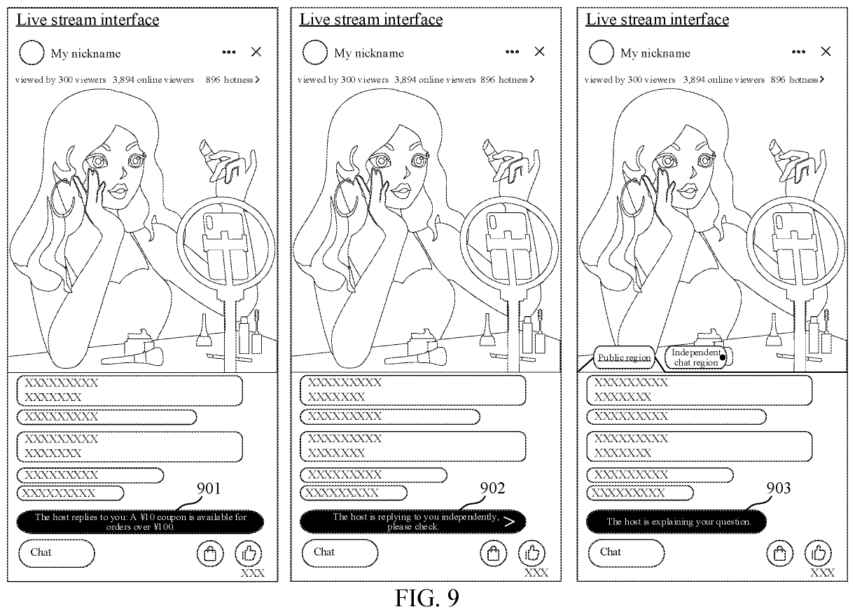

Illustratively, with reference to FIG. 7, a schematic diagram of an association with a recommended content according to an embodiment of this application is shown in FIG. 7. As shown in FIG. 7, recommended information 701 corresponding to the primarily-recommended content at the current moment set by the host account in the first live stream room is displayed in a live stream interface 700. In a default state, the first viewer account may directly publish an interactive content displayed in association with the recommended information 701. With the first recommended content being the recommended content selected by the first viewer account as an example, in response to receiving a viewing operation on at least one recommended content, a recommended content list 710 is displayed. The recommended content list 710 includes at least one recommended content. In response to receiving a selection operation on the first recommended content, when the first interactive content published by the first viewer account is displayed, recommended information 702 corresponding to the first recommended content is displayed in an associated mode.

In some embodiments, the viewer account and the host account in the first live stream room may perform a process of interacting with the first recommended content based on the recommended information displayed in association with the first interactive content. For example, when the recommended information is implemented as a product link, the viewer account and the host account in the first live stream room may view a product details interface associated with the first interactive content by clicking the product link displayed in association with the first interactive content.

In some embodiments, with the first recommended content being the recommended content selected by the first viewer account, and a live stream image in the live stream interface including an image content display region corresponding to at least one recommended content as an example, before operation 610, the method further includes: take, in response to receiving a selection operation on the image content display region corresponding to the first recommended content in the live stream image, the first recommended content as the recommended content associated with the first interactive content and selected by the first viewer account.

For example, when a host wears an outfit A (the first recommended content) in the live stream image, in response to receiving a selection operation on an image content display region corresponding to the outfit A in the live stream image, the outfit A is taken as the recommended content associated with the first interactive content and selected by the first viewer account.

In some embodiments, the image content display region corresponding to the at least one recommended content may be divided according to a configuration operation by the host account, or may be automatically divided through a recommended content identification model.

Illustratively, the host account configures and divides a corresponding image content display region for at least one recommended content displayed in the live stream image during the live stream. For example, an image center region is divided as an image content display region corresponding to a product A. In response to receiving a selection operation by the first viewer account on the image center region in the live stream image, the product A is taken as the recommended content associated with the first interactive content and selected by the first viewer account. With a product recommendation scenario as an example, a region with a preset proportion (for example, 20%) on the right side of a screen is set as a regularly-switched presentation location (i.e. the image content display region), recommended categories (i.e. at least one recommended content) are automatically switched every 5 minutes, and the host presets a presentation time period list of a plurality of products through a console. With gesture division as an example, the host dynamically divides the image content display region through a specific gesture (for example, making a heart shape with the left hand). After a camera of the terminal captures the predetermined gesture, an intelligent frame selection is activated, and a frame-selected region is taken the image content display region corresponding to at least one recommended content. With voice control division as an example, a corresponding region (for example, a circular region with a radius of 50 cm divided through voiceprint identification and spatial audio positioning) in a sound source direction is determined according to a host voice instruction (for example, “focus on here”), and taken as the image content display region corresponding to at least one recommended content. With line-of-sight detection as an example, a host's gaze focus region is determined through an eye movement detection technology (for example, a region at which the line of sight of the host dwells for over 2 seconds is continuously detected), and taken as the image content display region corresponding to at least one recommended content.

Illustratively, at least one recommended content is preset by the host account. In the live stream process, the recommended content displayed in the live stream image is automatically identified through the pretrained recommended content identification model, and a preset region range where the identified recommended content is located is divided into the image content display region corresponding to the recommended content. For example, when a product list preset by the host account includes a product B, in the live stream process, the recommended content identification model automatically identifies that the host holds the product B, and divides a preset region range where the product B is located into an image content display region (for example, a host hand region) corresponding to the product B. In response to receiving a selection operation by the first viewer account on the host hand region in the live stream image, the product B is used as the recommended content associated with the first interactive content and selected by the first viewer account.

In response to receiving the selection operation on the image content display region corresponding to the first recommended content in the live stream image, the first recommended content is taken as the recommended content associated with the first interactive content and selected by the first viewer account. Thus, the viewer account can directly associate the first interactive content with the first recommended content according to the image content display region, the incapability to precisely associate the accurate recommended content when the viewer does not acquire the recommended content can be avoided, and interaction efficiency can be improved.

In conclusion, in the method according to the embodiments of this application, when the first interactive content published by the first viewer account is displayed, the recommended information corresponding to the first recommended content is displayed in association with the first interactive content. Thus, the association between the interactive content and the recommended content can be improved, the recommended content associated with the interactive content can be intuitively acquired, the host account can give more precise feedback for the interactive content, and interaction efficiency can be improved.

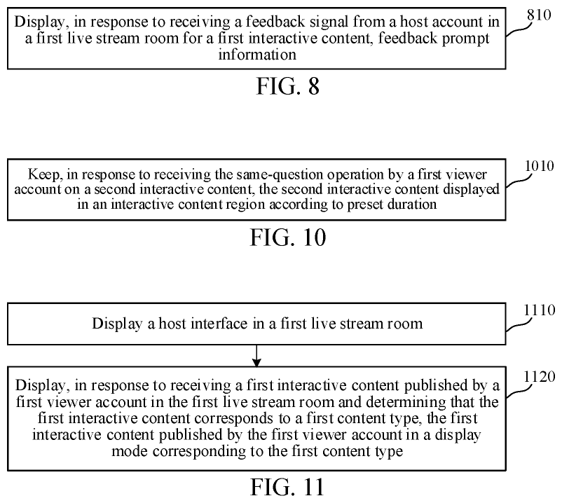

In some embodiments, the feedback content of the host account may further be received based on the interactive content, to implement a live stream interaction process based on the interactive content and the feedback content. With reference to FIG. 8, a fifth flowchart of an interaction method based on a live stream interface according to an embodiment of this application is shown in FIG. 8. The method may be performed by the terminal or the server, or may be jointly performed by the terminal and the server simultaneously. The embodiment of this application is described with the method performed by the terminal as an example. As shown in FIG. 8, after operation 240, the method further includes the following operations.

Operation 810: Display, in response to receiving a feedback signal from the host account in the first live stream room for the first interactive content, feedback prompt information.

The feedback signal is a signal transmitted by the server to the terminal of the first viewer account when the host account transmits the feedback content for the first interactive content, and is configured for instructing the terminal to receive the feedback content transmitted by the host account.

The feedback prompt information is configured for prompting the first viewer account to view the feedback content of the host account.

In some embodiments, the feedback prompt information includes at least one of public reply prompt information, independent reply prompt information, and explanation reply prompt information.

The public reply prompt information is configured for instructing the host account to reply to the first interactive content in a public interactive content display region.

The independent reply prompt information is configured for instructing the host account to reply to the first interactive content through a chat dialog box with the first viewer account.

The explanation reply prompt information is configured for instructing the host account to reply to the first interactive content through a live stream image representation in the first live stream room.

For the public reply prompt information, with an educational live stream scenario as an example, a teacher account is the host account, a student account is the viewer account, and the host account is answering a question of the viewer account. When the teacher account replies to the first interactive content in the public interactive content display region, the terminal of the first viewer account displays the public reply prompt information. The prompt information may exist in a form of a pop-up window or a floating prompt, and is, for example, “The teacher publicly replies to your question, please view the interactive region.”

For the independent reply prompt information, with a game live stream scenario as an example, a game host account, the host account, is interacting with viewers. When the host replies to the first interactive content through the chat dialog box with the first viewer account, the terminal of the first viewer account displays the independent reply prompt information. The prompt information may exist in a form of a new message prompt in the dialog box or high-brightness display a chat window, and is, for example, “The host replies to your question through the dialog box, please view reply information.”

For the explanation reply prompt information, with a food live stream scenario as an example, a food blogger account, the host account, is live-streaming a cooking process. When the blogger replies to the first interactive content through the live stream image representation in the first live stream room, the terminal of the first viewer account displays the explanation reply prompt information. The prompt information may exist in a form of a text prompt or a graphic identifier in the live stream image, and is, for example, “The blogger is answering your question through the live stream image, please watch.”

In some embodiments, the interactive content display region includes a public region and an independent region. The public region is configured for displaying the interactive content publicly published in the first live stream room. The independent region is configured for displaying the interactive content between the host account and the first viewer account in the chat dialog box based on the independent reply content of the host account for the first viewer account.

In some embodiments, the viewer account may perform a switch between the public region and the independent region for display based on a public region button and an independent region button in the live stream interface, or may display the public region and the independent region in the live stream interface simultaneously.

In some embodiments, an unread prompt identifier correspondingly exists in the interactive content display region. With the unread prompt identifier implemented as a red dot as an example, when the viewer views the public region, in a case of receiving the independent reply content from the host account, the independent region button and a red-dot identifier are displayed in an associated mode. In response to a switch to the independent region by the viewer, associated display of the red-dot identifier and the independent region button is canceled. When the viewer views the independent region, in a case of receiving an interactive content published by another account in the public region, the public region button and the red-dot identifier are displayed in an associated mode. In response to a switch to the public region by the viewer, the associated display of the red-dot identifier and the public region button is canceled.

Illustratively, with reference to FIG. 9, a schematic diagram of a feedback prompt according to an embodiment of this application is shown in FIG. 9. As shown in FIG. 9, in response to receiving the feedback signal from the host account in the first live stream room for the first interactive content in a public interactive content display region, public reply prompt information 901 is displayed in the public interactive content display region. After attached to the bottom of the display region for 10 seconds, the public reply prompt information scrolls along with other public interactive contents in the interactive content display region. In response to receiving the feedback signal from a live stream account in the first live stream room for the first interactive content through the chat dialog box with the first viewer account, independent reply prompt information 902 is displayed, and display is canceled after the independent reply prompt information is attached to the bottom of the display region for 10 seconds. In response to clicking the independent reply prompt message 902 by the first viewer account, a switch from the public interactive content display region to the chat dialog box is performed. In response to receiving the feedback signal from the live stream account in the first live stream room for the first interactive content through the live stream image representation in the first live stream room, explanation reply prompt information 903 is displayed to prompt the first viewer account that “the host is explaining your problem”, and display is canceled after the explanation reply prompt information is attached to the bottom of the display region for 10 seconds.

In some embodiments, an unread prompt identifier correspondingly exists in the interactive content display region. With the unread prompt identifier implemented as a numeral as an example, when the viewer views the public region, in a case of receiving the independent reply content from the host account, the independent region button and a numeral identifier are displayed in an associated mode. The numeral identifier denotes a total number of unread information. In response to a switch to the independent region by the viewer, a first number of information transmitted by the host account is determined, a difference between the total number and the first number is determined, the difference is taken as a second number, and the total number for the numeral identifier is updated to the second number. When the viewer views the independent region, in a case of receiving the interactive content published by another account in the public region, the public region button and the numeral identifier are displayed in an associated mode. The numeral identifier denotes a total number of unread information. In response to a switch to the public region by the viewer, a third number of the interactive contents transmitted by another account is determined, a difference between the total number and the third number is determined, the difference is taken as a fourth number, and the total number for the numeral identifier is updated to the fourth number.

Illustratively, when the viewer views the public region, in a case of receiving the independent reply content from the host account, the independent region button and the numeral identifier are displayed in the associated mode. The numeral identifier denotes the total number of the unread information. For example, the total number of the unread information is 10. In response to the switch to the independent region by the viewer, the first number of the information transmitted by the host account is determined. For example, the first number is 6. The difference between the total number and the first number is 4. 4 is taken as the second number, and the numeral identifier 10 is updated to 4. When the viewer views the independent region, in a case of receiving the interactive content published by another account in the public region, the public region button and the numeral identifier are displayed in the associated mode. The numeral identifier denotes the total number of the unread information. For example, the total number of the unread information is 10. In response to the switch to the public region by the viewer, the third number of the interactive contents transmitted by another account is determined. For example, the first number is 7. The difference between the total number and the third number is 3. 3 is taken as the fourth number, and the numeral identifier 10 is updated to 3.

In conclusion, in the interaction method based on a live stream interface according to the embodiments of this application, a plurality of types of feedback prompt information are provided, so that the viewer account can be prompted to view the feedback content of the host account for the first interactive content in a targeted mode, the viewer account can be prevented from missing the feedback content, ineffective feedback can be reduced, and interaction efficiency can be improved.

In some embodiments, the viewer account may further perform the same-question operation on the interactive content in the interactive content display region. Illustratively, the interactive content display region includes a plurality of interactive contents published by the viewer account in the first live stream room, and the plurality of interactive contents include a second interactive content. With reference to FIG. 10, a sixth flowchart of an interaction method based on a live stream interface according to an embodiment of this application is shown in FIG. 10. The method may be performed by the terminal or the server, or may be jointly performed by the terminal and the server simultaneously. The embodiment of this application is described with the method performed by the terminal as an example. As shown in FIG. 10, the method includes the following operations.

Operation 1010: Keep, in response to receiving the same-question operation by the first viewer account on the second interactive content, the second interactive content displayed in the interactive content display region according to preset duration.

With the second interactive content corresponding to the question type as an example, the same-question operation is configured for indicating that the first viewer account publishes the same interactive content as the second interactive content.

Illustratively, the interactive content display region includes an interactive content B published by a viewer A. In response to receiving the same-question operation by a viewer C for the interactive content B, in a process of slidably displaying a plurality of interactive contents in the interactive content display region in sequence, the interactive content B remains and is kept displayed for 5 seconds.

A rapid and convenient same-question function for different viewer accounts relative to the same interactive content is implemented while repeated display of the same interactive content in the interactive content display region is reduced, so that question efficiency is improved.

In some embodiments, the first live stream room includes at least one recommended content, at least one recommended content including a second recommended content and a third recommended content. The second interactive content is associated with the second recommended content, a display mode of the second interactive content corresponds to a second content type, and the same-question process based on the same-question operation may include the following operations.

Operation 1: Automatically copy, in response to receiving the same-question operation by the first viewer account on the third recommended content through the second interactive content, the second interactive content, generate a third interactive content, and publish the third interactive content.

Operation 2: Display, when the third interactive content published by the first viewer account is displayed, recommended information corresponding to the third recommended content in association with the third interactive content.

A display mode of the third interactive content corresponds to the second content type.

Illustratively, the interactive content display region includes a question content 1 published by the viewer A. The question content 1 is associated with a product m. The question content 1 is configured for inquiring of the host account about a preferential price of the product m. For example, the question content 1 may be “what is the preferential price”. In response to receiving the same-question operation, based on a product n, by the viewer B on the question content 1, the question content 1 is automatically copied, and a question content 2 is generated and published. When the question content 2 is displayed, a purchase link of the product n is displayed in an associated mode. The question content 2 is configured for inquiring of the host account about a preferential price of the product n. For example, being the same as the question content 1, the question content 2 may be “what is the preferential price”.

By receiving the same question operation, based on the third recommended content, by the first viewer account on the second interactive content, the same-question function of a rapid switch of the associated recommended content is achieved, manual operation time is shortened, and interactive rapidness and convenience and same-question operation efficiency are improved.

In conclusion, in the method according to the embodiments of this application, in response to receiving the same-question operation by the first viewer account on the second interactive content, the second interactive content is kept displayed in the interactive content display region according to the preset duration. Thus, highlighting of a highly-hot interactive content can be maintained while repeated transmission of the same interactive content is reduced, the host can be prevented from ignoring a crucial interactive content, and interaction efficiency can be improved.

With reference to FIG. 11, a seventh flowchart of an interaction method based on a live stream interface according to an embodiment of this application is shown in FIG. 11. The method may be performed by the terminal or the server, or may be jointly performed by the terminal and the server simultaneously. The embodiment of this application is described with the method performed by the terminal as an example. As shown in FIG. 11, the method includes the following operations.

Operation 1110: Display a host interface in the first live stream room.

The host interface is a display interface corresponding to the host account in the first live stream room, and the host account is an account master-controlled by the current terminal.

The first live stream room indicates a virtual room created by the host account in a live stream application, and is a type of network live stream program configured for a real-time live stream interaction.

In some embodiments, the first live stream room is configured for presenting a live stream interface of the host account. For the terminal of the host account, the first live stream room performs live stream presentation based on operation control by the host, and receives an interactive operation by the host account. For the terminal of the viewer account, the first live stream room is configured for presenting the live stream interface, and receiving an interactive operation by the viewer account. The embodiment of this application is described with the terminal of the host account as an example.

In some embodiments, the first live stream room may be a live stream room in any form, such as a virtual game live stream room, a real-person performance live stream room, an online variety live stream room, an online sales live stream room, and an online teaching live stream room, which is not limited in the embodiments of this application.

The host interface may include the live stream interface disclosed by the host account to the viewer account, and may further include a backend control interface of the host account.

In some embodiments, the host interface includes the interactive content display region. The interactive content display region is configured for displaying the interactive content published by at least one of the viewer account and the host account in the first live stream room.

Operation 1120: Display, in response to receiving the first interactive content published by the first viewer account in the first live stream room, and determining that the first interactive content corresponds to the first content type, the first interactive content published by the first viewer account in the display mode corresponding to the first content type.

The first content type is a content type configured for the first interactive content when the first viewer account generates the first interactive content.

Illustratively, the first interactive content published by the first viewer account is displayed in the live stream interface of the host interface in the display mode corresponding to the first content type. An interface representation in the live stream interface corresponding to the host account is the same as an interface representation in the live stream interface corresponding to the viewer account. Alternatively, the first interactive content published by the first viewer account is displayed in a backend message interface of the host interface in the display mode corresponding to the first content type. The backend message interface is a message interface open to the host account and configured for summarizing and displaying interactive contents in the first live stream room. The display mode of the first interactive content in the backend message interface may be identical to or different from the display mode in the live stream interface, which is not limited in the embodiments of this application.

When the first interactive content published by the first viewer account is displayed in the live stream interface of the host interface in the display mode corresponding to the first content type, the host account may perform an interactive operation on the first interactive content, which includes, but is not limited to, a display-on-screen operation, a reply operation, an independent chat operation, a muting operation, a blocking operation, etc.

In some embodiments, a first interactive option and a second interactive option are displayed in the interactive content display region. The first interactive option is configured for displaying interactive contents corresponding to a plurality of content types, and the second interactive option is configured for displaying an interactive content corresponding to the first content type. In response to receiving a trigger operation on the second interactive option, a plurality of interactive contents corresponding to the first content type are displayed in the interactive content display region. The plurality of interactive contents include the first interactive content.

Illustratively, the interactive content display region includes a public region and a question region. The public region is configured for displaying a public interactive content published in the first live stream room, and the question region is configured for displaying a question interactive content published in the first live stream room. The first interactive option is implemented as a public region option, and the second interactive option is implemented as a question region option. In response to receiving a trigger operation on the public region option, the public region is displayed. In response to receiving a trigger operation on the question region option, the question region is displayed. With an educational live stream as an example, the public region may display real-time feedback such as “the teacher explains clearly!” transmitted by a student, or a shortcut emoticon such as “666” to create a learning atmosphere. The teacher may actively initiate a topic discussion in the region, for example, “Do you understand the formula?”. The question region may display “Could you please explain the concept of quantum entanglement again?” posed by the student for the knowledge point. The teacher may centrally view high-quality questions in the region during breaks between knowledge point explanation, to prevent important questions from being submerged by screen flooding. During a live stream in an e-commerce sales scenario, the public region may display real-time demand transmitted by viewers, such as “Does this sweatshirt come in size XS?” and “placed an order, await for prize drawing”. The host may boost conversions through rapid response. Promotional information such as “last 10 pieces for flash sale” may also be displayed at the top of the region. The question region may display and collect professional inquiries including “Is this skincare product suitable for sensitive skin?” and “What are ingredient differences between two versions?”. The co-host team may retrieve product manuals in real time to provide the host with standard answer scripts, ensuring reply accuracy. With a game competition commentary scenario as an example, the public region may display emotional expression during game watching, such as “The team fight is amazing!” transmitted by the viewer, or bullet-screen comments that predict competition outcomes to enhance the sense of participation. The commentator may capture viewers' excitement points from the region, and adjust the commentary rhythm. The question region may display and focus on technical questions such as “What is the combo sequence used just now?”. The professional commentator may chip a game replay segment, and conduct synchronized technical analysis and instruction in the question region.

In some embodiments, the interactive content display region further includes an independent region. The independent region is configured for displaying a chat box between the host account and the viewer account and pulled based on the question content. Illustratively, a third interactive option is further displayed in the interactive content display region. The third interactive option is configured for displaying a chat box pulled based on the interactive content corresponding to the first content type. The third interactive option is implemented as an independent region option. In response to receiving a trigger operation on the independent region option, the independent region is displayed.

With a question interaction as an example, the interactive content display region in the host interface includes the public region, the question region, and the independent region. The public region is configured for publicly displaying the interactive contents publicly published by the host account and the viewer account in the first live stream room. The question region is configured for displaying the question content published by the viewer account in the first live stream room. The independent region is configured for displaying independent chat boxes corresponding to a plurality of viewer accounts respectively and pulled by the host account based on the question content.

In the embodiments of this application, the interactive content is divided into the public region and the question region, so that the viewers can more clearly see different types of interactive contents, and information readability and organization are improved. The viewers can select to view the content in the public region or in the question region according to their own interests and demand, and thus personalized content presentation can be achieved. With the independent region set, the host can perform one-to-one interactions with a plurality of viewers, so that interaction efficiency and privacy can be improved. The host can interact with the plurality of viewers simultaneously through the independent region, so that interaction efficiency can be improved.

In some embodiments, an unread prompt identifier correspondingly exists in the interactive content display region, and is configured for prompting the host account to view an unread interactive content.

Illustratively, when the host account views the public region, in response to receiving the first interactive content corresponding to the first content type, a comment region option and the unread prompt identifier are displayed in an associated mode. In response to a switch to the comment region by the host account, associated display of the comment region option and the unread prompt identifier is canceled. When the host account views the public region or the comment region, in response to receiving an interactive content published by the viewer account in the chat dialog box, the independent region option and the unread prompt identifier are displayed in an associated mode. In response to a switch to the independent region by the host account, display of the independent region option and the unread prompt identifier is canceled.

In a case that the host account does not view the interactive content in the chat dialog box, the chat dialog box in the independent region correspondingly displays the unread prompt identifier.

In the embodiments of this application, the host account is reminded to view a new interactive content in real time through the unread prompt identifier, so that it is ensured that the host does not miss important interactive information. Through in-time reminding, the host can respond to the interactive content of the viewer more rapidly, so that interactivity and timeliness of the live stream can be improved. The unread prompt identifier may perform classified reminding according to the type of the interactive content, so that the host can manage different interactive regions more efficiently.

For the plurality of interactive contents of the first content type, the host account may select a corresponding feedback type that includes, but is not limited to, a public reply type, an independent reply type, and an explanation reply type. The public reply type is configured for instructing that a feedback content of the host account for the first interactive content be publicly displayed in the public interactive content display region. The independent reply type is configured for instructing the host account to display a feedback content of the host account for the first interactive content in the independent chat box with the first viewer account. The explanation reply type is configured for instructing the host account to reply to the first interactive content through a live stream image presentation.

Illustratively, for the first interactive content corresponding to the first content type, the host account clicks a public reply button to display a public reply content transmission region. The public reply content transmission region is configured for generating a public reply content for the first interactive content. For the first interactive content corresponding to the first content type, after the host account clicks an independent chat reply button, the chat dialog box between the host account and the first viewer account is displayed, and the first interactive content and an independent reply content transmission region are displayed in the chat dialog box. The independent reply content transmission region is configured for generating an independent reply content for the first interactive content. For the first interactive content corresponding to the first content type, after the host account clicks an explanation reply button, an explanation prompt message is published in the first live stream room. The host account may configure whether to record a current explanation content, and configure a function of reading an explanation replay.

In some embodiments, the first interactive content corresponding to the first content type is marked with a replied tag after the feedback content is received from the host account.

In the embodiments of this application, a plurality of feedback types are provided. The host can select a proper interaction mode according to the property of the interactive content and the viewer demand, so that diversity of the interactions can be increased. With different feedback types, the host can manage the interactive content more efficiently, and respond to the viewer demand rapidly, and thus live stream interaction efficiency can be improved. According to own preference, the viewer can select a method for interacting with the host, for example, a public reply, an independent chat reply, or an explanation reply, so that personalized interaction experience of the viewer can be improved.

In some embodiments, the host account may further perform an ignoring operation on the first interactive content corresponding to the first content type. After the ignoring operation is received, the first interactive content is marked with an ignored tag.

In some embodiments, the host interface further includes a screening function for the interactive content of the first content type. With the question region as an example, in a default state, all question contents in the first live stream room are displayed. According to a screening operation by the host account, interactive contents corresponding to an answered state, an unanswered state, an ignored state, etc. respectively may be screened and displayed.

In the embodiments of this application, with the screening function, the host can rapidly find an interactive content in a specific state, for example, an unanswered or ignored problem, so that efficiency of managing the interactive content can be improved. By screening the answered interactive contents, the host can avoid repeatedly answering the same question, so that an interaction flow can be optimized, and feedback time can be saved. The host can reply to an unanswered interactive content in a targeted mode according to a screening result, so that comprehensiveness and timeliness of the interaction can be improved.

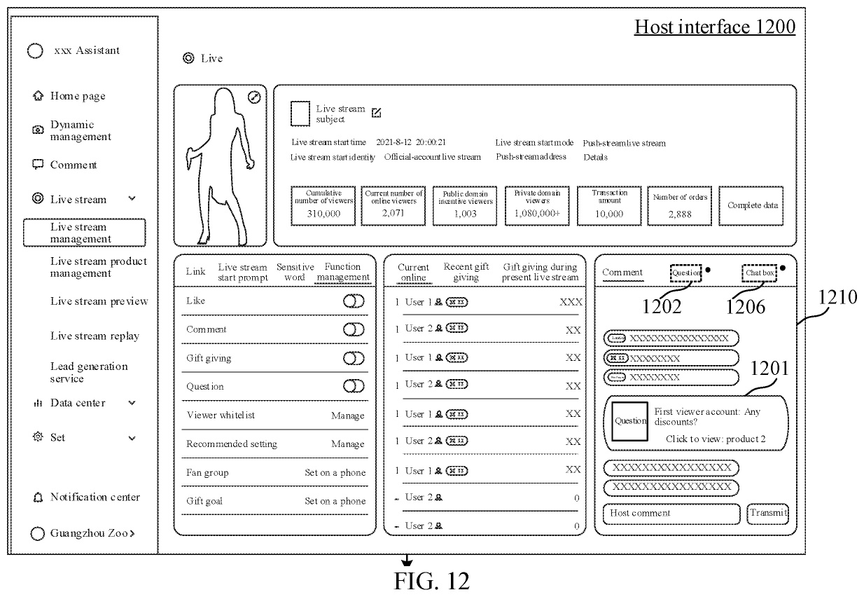

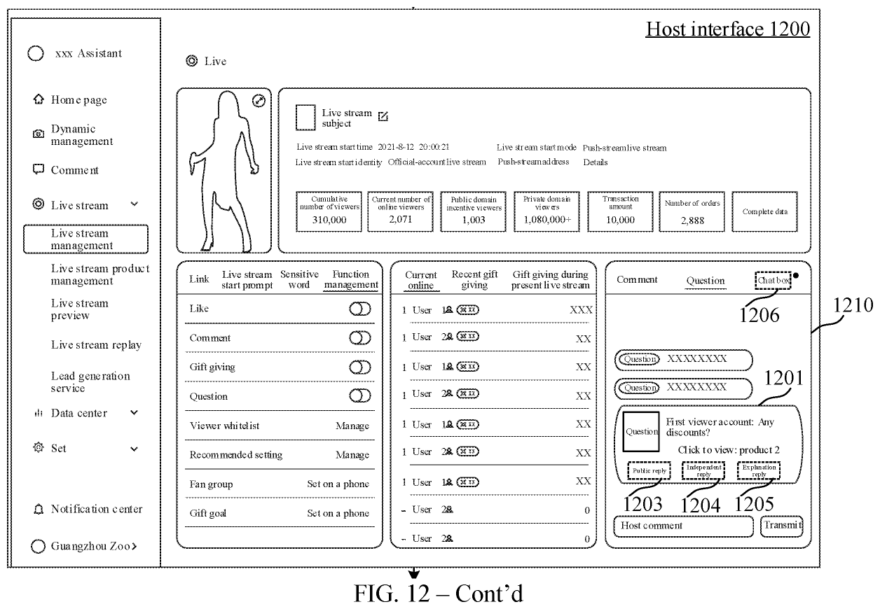

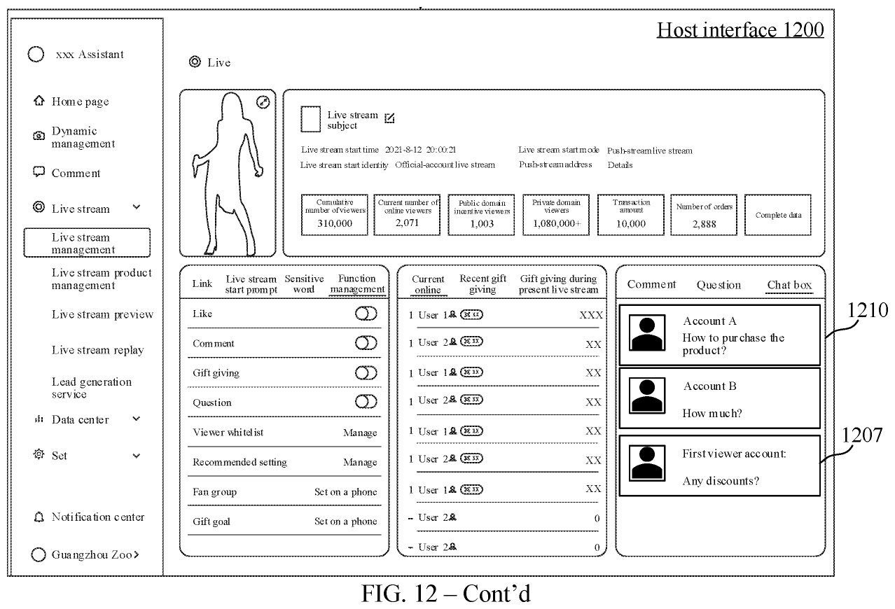

Illustratively, with reference to FIG. 12, a schematic diagram of a host interface according to an embodiment of this application is shown in FIG. 12. As shown in FIG. 12, a host interface 1200 in a first live stream room is displayed. In response to receiving a first interactive content 1201 published by a first viewer account in the first live stream room and determining that the first interactive content 1201 corresponds to a question type, the first interactive content 1201 published by the first viewer account is displayed in a display mode corresponding to the question type. In response to receiving a trigger operation on a question region option 1202, a plurality of interactive contents corresponding to the question type are displayed in an interactive content display region 1210. The plurality of interactive contents include the first interactive content 1201. The first interactive content 1201 corresponds to a public reply control 1203, an independent reply control 1204, and an explanation reply control 1205. In response to receiving a trigger operation on an independent region option 1206, at least one independent chat box is displayed. In a case of receiving an independent reply operation on the first interactive content 1201, at least one independent chat box includes a chat box 1207 between the host account and the first viewer account.

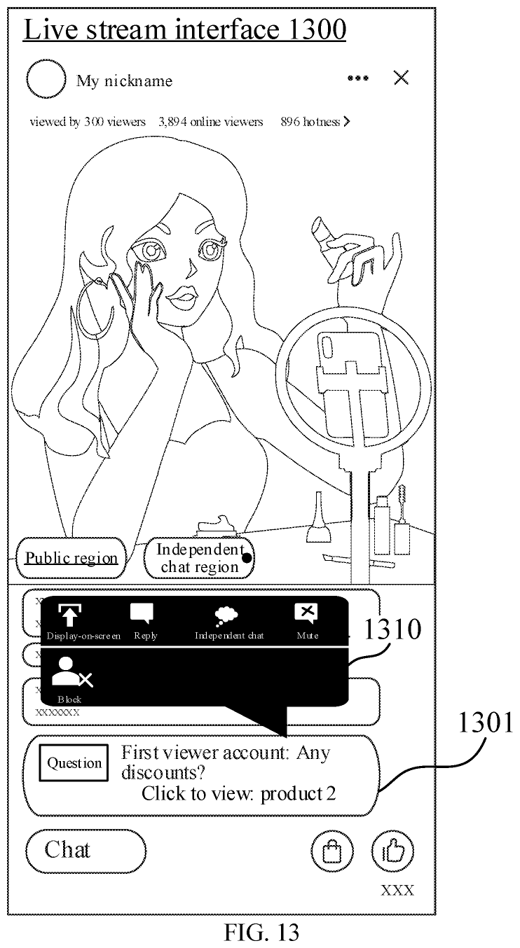

Illustratively, with reference to FIG. 13, a schematic diagram of an interaction based on a host interface according to an embodiment of this application is shown in FIG. 13. As shown in FIG. 13, the host account may further display a first interactive content 1301 in a live stream interface 1300 corresponding to the host interface. An interactive control 1310 for the first interactive content 1301 may be triggered in the live stream interface 1300 through a long-press operation on the first interactive content 1301.

In some embodiments, before operation 1120, in a process of configuring the first live stream room, the host account is required to activate a publishing function for a specific-type content, for example, activate a live stream room question function. Then, the viewer account may publish a question-type content in the first live stream room.

Illustratively, a configuration interface is displayed in the host interface. The configuration interface includes a configuration control of the first content type. In response to receiving an activation operation on the configuration control corresponding to the first content type, the publishing function for the interactive content corresponding to the first content type is activated in the first live stream room. In response to receiving a deactivation operation on the configuration control corresponding to the first content type, the publishing function for the interactive content corresponding to the first content type is deactivated in the first live stream room.

In some embodiments, a plurality of question contents in the question region may be arranged and displayed in a reverse order of question moments at which the question contents are received, or may be arranged and displayed in a reverse order of reply moments of the question contents.

In some embodiments, when the host account explains and replies to the first interactive content, the first interactive content is displayed at the top of the question region.

In some embodiments, the question contents may alternatively be arranged and displayed in sequence according to hotness in descending order. The hotness of the question contents may be determined according to interactive data of the viewer accounts on the question contents. For example, the hotness of the question content is determined according to at least one type of the interactive data such as a number of likes of the viewer accounts for the same question content, a number of same-question operations, and a number of views of recommended information associated with the question content. The number of likes, the number of same-question operations, and the number of views are in a positive correlation with the hotness.

In the embodiments of this application, arrangement is performed in the reverse order of the question moments, and thus it can be ensured that a latest question content is displayed first, and timeliness of interaction can be maintained. With the reply moments arranged in the reverse order, the host can rapidly view a question content most recently answered, and acquire a progress of the interaction. When the host account perform the explanation reply, the first interactive content is displayed at the top to be highlighted, and thus it is ensured that all viewers can see the detailed reply of the host. Popular topics can be highlighted according to the hotness in descending order, and an interaction rate can be increased.

When the interactive content corresponding to the first content type is associated with a recommended content, a plurality of interactive contents for the same recommended content are automatically aggregated and displayed.

Illustratively, the question content is associated with the product. The backend automatically aggregates the plurality of question contents corresponding to the same product. When the host account screens question contents of the product A, the plurality of question contents corresponding to the product A are displayed.

In the embodiments of this application, the plurality of interactive contents for the same recommended content are aggregated and displayed, so that the interactive contents for the same recommended content can be rapidly processed, repeated interactive contents can be reduced, interactive content processing time can be saved, and efficiency of interactive content batch processing can be improved.

For the plurality of interactive contents of the first content type corresponding to the same recommended content, a keyword in the interactive contents may be automatically extracted through an artificial intelligence model, and interactive contents whose keyword similarity reaches a preset similarity are deemed as the same interactive content. The host account may synchronously process the same interactive content published by different viewer accounts in batch.

Illustratively, for the product M, product inquiry contents transmitted by the viewer account A, the viewer account B, and the viewer account C respectively are received. It is detected through artificial intelligence (AI) that the three product inquiry contents include a price inquiry keyword, and thus the three product inquiry contents are deemed as the same price inquiry content. When the host account replies to the product inquiry content transmitted by the viewer account A, the product inquiry contents transmitted by the viewer account B and the viewer account C respectively are automatically and synchronously answered. With the independent reply as an example, when the host account independently replies to the product inquiry content transmitted by the viewer account A through the chat dialog box, and publishes the first feedback content to the viewer account A, chat dialog boxes for the viewer account B and the viewer account C respectively are automatically and synchronously pulled, the first feedback content is automatically published to the viewer account B in the chat dialog box corresponding to the viewer account B, and the first feedback content is automatically published to the viewer account C in the chat dialog box corresponding to the viewer account C.

In conclusion, in the method according to the embodiments of this application, in a case of receiving the first interactive content published by the first viewer account in the first live stream room and determining that the first interactive content corresponds to the first content type, the first interactive content published by the first viewer account is displayed in the display mode corresponding to the first content type, so that a solution in which the display mode of the interactive content corresponds to the content type is achieved, and the host can rapidly determine the content type of the interactive content according to the display mode of the interactive content. Accordingly, when there is a large number of interactive contents, an interactive content of a specific content type can be highlighted. A specific display mode can assist the host in perceiving the interactive content of the specific content type in time, so that the host can give targeted feedback based on the interactive content in time, and interaction efficiency can be improved.

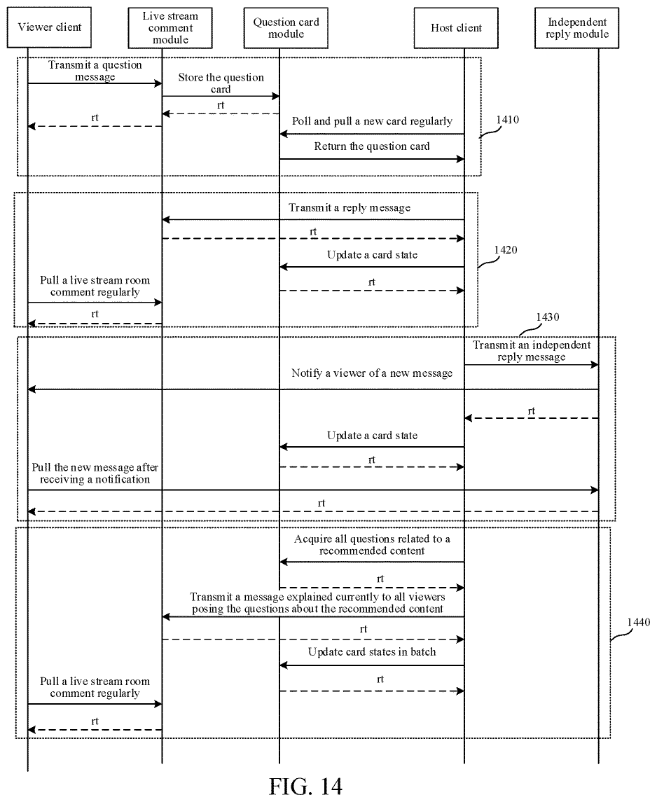

The interaction flow based on a live stream interface according to the embodiments of this application is described with reference to the above embodiments. The embodiments of this application are described with the interactive content implemented as the comment in the live stream room, and the interactive content corresponding to the first content type implemented as the question content as an example. Illustratively, with reference to FIG. 14, a schematic diagram of an overall interaction flow based on a live stream interface according to an embodiment of this application is shown in FIG. 14. As shown in FIG. 14, an interaction flow based on a live stream interface includes a client of the viewer, a client of the host, a live stream comment module, a question card module, and an independent reply module. The live stream comment module is configured for providing a live stream room comment function (for example, publishing the interactive content). The question card module is configured for processing the question content (for example, the published first interactive content corresponding to the first content type) in the live stream room. The independent reply module is configured for processing the independent reply for the question content (for example, providing an independent reply feedback content for the first interactive content corresponding to the first content type). For a live stream room comment process 1410, the client of the viewer transmits a question message to the live stream comment module, the live stream comment module stores a question card into the question card module, the client of the host polls and pulls the card regularly, and the question card module returns the question card to the client of the host. For a public reply process 1420, the client of the host transmits a reply message to the live stream comment module, the client of the host updates a card state to the question card module, and the client of the viewer regularly pulls live stream room comments from the live stream comment module. For an independent reply process 1430, the client of the host transmits an independent reply message to the independent reply module, and the independent reply module notifies the viewer of a new message; and the client of the viewer pulls the new message from the independent reply module after receiving a notification. For an explanation reply process 1440, the client of the host acquires questions related to the corresponding recommended content from the question card module, transmits information explained currently to all viewers posing the questions about the recommended content through the live stream comment module, and updates card states of the question card module in batch; and the client of the viewer regularly pulls live stream room comments from the live stream comment module. The rt returned by each execution subject in the interaction process indicates a read receipt (RT).

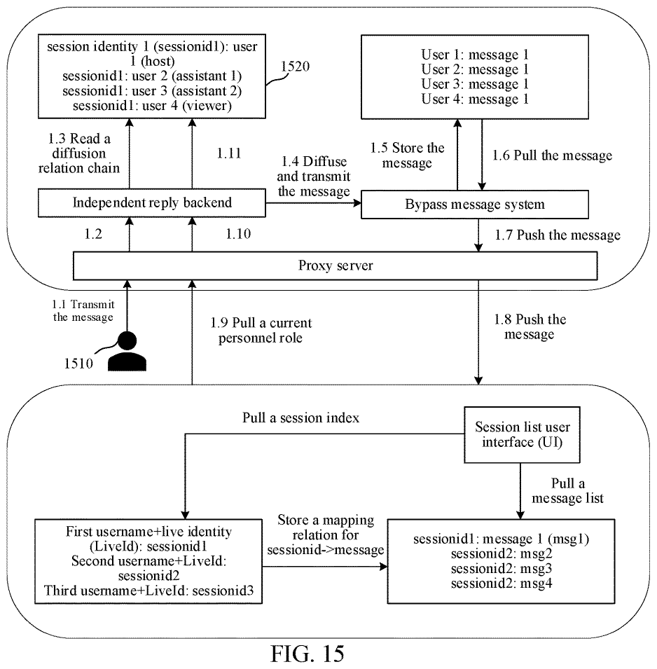

A backend processing flow for the above independent reply process is further described. Illustratively, with reference to FIG. 15, a schematic diagram of an independent reply technical flow according to an embodiment of this application is shown in FIG. 15. As shown in FIG. 15, a session identity (sessionid) is configured for identifying a session, a username is configured for identifying a viewer account in an encrypted mode, and a live identity (LiveId) is configured for identifying a first live stream room. A transmitter 1510 transmits a message, a proxy server receives the message, and forwards the message to an independent reply backend, and the independent reply backend reads a diffusion relationship chain 1520. The diffusion relationship chain 1520 is configured for indicating that when a session identified by a sessionid1 is processed, a message in the independent reply process may be synchronized to a user 1 to a user 4 including a host, an assistant 1, an assistant 2, and the viewer. The independent reply backend diffuses and transmits the message to a bypass message system according to the diffusion relationship link 1520. The bypass message system performs message storage and message pulling. A message 1 is separately synchronized to the user 1 to the user 4. The bypass message system pushes the message to the proxy server. The proxy server pulls a session index and a message list from a session list user interface (UI) in a process of pushing the message to the client. The session index includes a correspondence relationship between the username as well as the live stream room identity and the session identity. The session identity may be determined according to the username and the live stream room identity. A mapping relationship between the session identity and a message identity (msgi) is stored, so that the message list is pulled according to the session identity, where the sessionid1 corresponds to an msg1, and a sessionid2 corresponds to an msg2 to an msg4. Specifically, in the above independent reply technical flow, a personnel role corresponding to the current transmitter 1510 may further be pulled to the proxy server according to the session list UI. The proxy server synchronizes the personnel role to the independent reply backend, and the independent reply backend determines the diffusion relationship chain according to the personnel role.

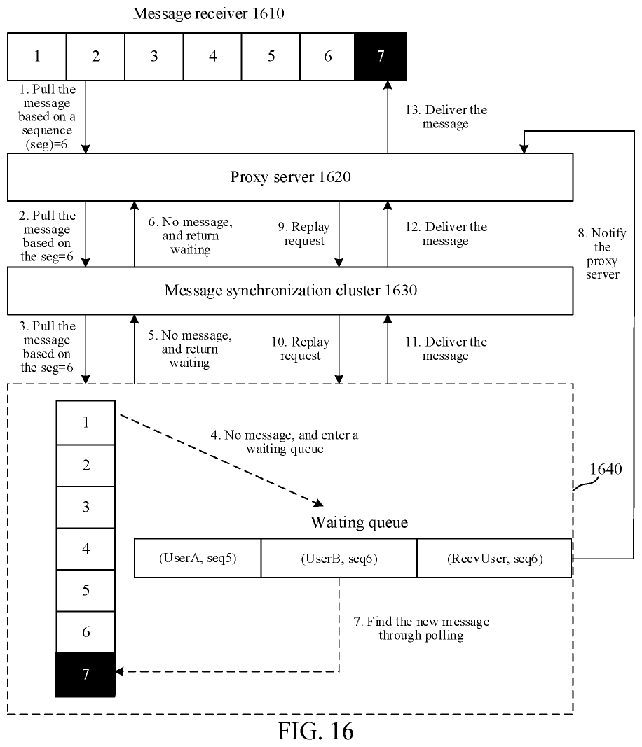

A comment interaction performed by a message receiver is described. Illustratively, with reference to FIG. 16, a schematic diagram of an interaction of the live stream comment module according to an embodiment of this application is shown in FIG. 16. As shown in FIG. 16, for a message receiver 1610 in the first live stream room, a message is pulled from a proxy server 1620 according to a current latest message identity (a sequence (seq)=6) of a message queue. The proxy server 1620 pulls the message from a message synchronization cluster 1630. The message synchronization cluster 1630 pulls the message from a message cache 1640 corresponding to the first live stream room. When it is determined according to the current latest message identity that there is no new message currently, a waiting queue is entered, and waiting is returned to the message synchronization cluster 1630 and the proxy server 1620. When the waiting queue finds a new message through polling from the message cache 1640 (the current latest message identity is updated to an seq=7), the proxy server 1620 is notified, and the proxy server 1620 replays a request to the message synchronization cluster 1630. The message synchronization cluster 1630 replays the request to the message cache 1640. The message cache delivers the latest message to the message synchronization cluster 1630 and the proxy server 1620 in sequence. Finally, the proxy server 1620 delivers the latest message to the message receiver 1610.

An application scenario of the interaction method based on a live stream interface according to the embodiments of this application is described with reference to the above embodiments. The interaction method based on a live stream interface according to the embodiments of this application may be applied to any live stream interaction scenarios such as a virtual game live stream scenario, a real-person performance live stream scenario, an online variety live stream scenario, an online sales live stream scenario, and an online teaching live stream scenario, which is not limited in the embodiments of this application.
1. The interaction method based on a live stream interface applied to the online sales live stream scenario is described as an example.

In a case that a host account authorizes that an interactive content of a first content type can be published in the first live stream room, a question type is described as an example.

For a terminal of a viewer account, a live stream interface in the first live stream room is displayed. The first live stream room includes the viewer account watching a live stream, and the viewer account includes a first viewer account master-controlled by the current terminal. An interactive content transmission region and a content type option are displayed. The interactive content transmission region is configured for generating an interactive content published by the first viewer account in the first live stream room, and the content type option is configured for determining a content type of the interactive content. A generation operation on a first interactive content in the interactive content transmission region is received, and a configuration operation on a question type is received for a question option. The first interactive content published by the first viewer account is displayed in a display mode corresponding to the question type. For example, a marked question tag is displayed when the first interactive content is displayed.

In some embodiments, the first interactive content published by the first viewer account is publicly displayed in a comment region in the first live stream room, and the first interactive content is marked with the question tag. Alternatively, the first interactive content published by the first viewer account is displayed in the comment region in a high-brightness display mode corresponding to the question type.

For example, the first interactive content is displayed in the comment region through a red text color, and interactive contents corresponding to other content types are displayed through a black text color.

In some embodiments, the question option corresponds to a check control. The question type is switched from a deselected state to a selected state by receiving a selection operation on the check control of the question option, so as to publish the question content corresponding to the question type.

In some embodiments, in response to determining that the first interactive content generated in the interactive content transmission region includes a question mark or a preset inquiry keyword, for example, “how much”, “whether”, “why”, and “how”, an automatic switch of the check control corresponding to the question option from a deselected state to a selected state is displayed.

In some embodiments, the first live stream room includes at least one product, at least one product includes a first product, and when the question content published by the first viewer account is displayed, a product link corresponding to the first product is displayed in association with the question content.

In some embodiments, the first product is a primarily-recommended content at a current moment set by the host account in the first live stream room. The first product is a product associated with the question content and selected by the first viewer account from at least one product.

Illustratively, the first product is selected by the first viewer account, and a live stream image in the live stream interface includes image content display regions corresponding to at least one product respectively. In response to receiving a selection operation on an image content display region corresponding to the first product in the live stream image, the first product is taken as the product associated with the question content and selected by the first viewer account.

In some embodiments, in response to receiving a feedback signal from the host account in the first live stream room for the question content, feedback prompt information is displayed. The feedback prompt information is configured for prompting the first viewer account to view a feedback content of the host account.

In some embodiments, the feedback prompt information includes at least one of public reply prompt information, independent reply prompt information, and explanation reply prompt information. The public reply prompt information is configured for instructing the host account to reply to the question content in a public interactive content display region. The independent reply prompt information is configured for instructing the host account to reply to the question content through a chat dialog box with the first viewer account. The explanation reply prompt information is configured for instructing the host account to reply to the question content through a live stream image representation in the first live stream room.

In some embodiments, the comment region in the first live stream room includes a plurality of comments published by viewer accounts in the first live stream room. The plurality of comments include a question content B published by a viewer account A. In response to receiving the same-question operation by the first viewer account on the question content B, the question content B is kept displayed in the comment region according to preset duration.

In some embodiments, the first live stream room includes at least one product, at least one product includes a product M and a product N, and the above question content B is associated with the product M. In response to receiving the same-question operation, based on the product N, by the first viewer account on the question content B, the question content B is automatically copied, and a question content C is generated and published. When the question content C published by the first viewer account is displayed, a product link of the product N is displayed in association with the question content C. A display mode of the question content C corresponds to the question type.

For a terminal of the host account, a host interface in the first live stream room is displayed. The host interface is a display interface corresponding to the host account in the first live stream room, and the host account is an account master-controlled by the current terminal. In response to receiving the question content published by the first viewer account in the first live stream room, the question content is displayed in the display mode corresponding to the question type.

A comment region option and a question region option are displayed in a live stream room comment region of the host interface. The comment region option is configured for displaying all public comments in the first live stream room, and the question region option is configured for displaying the question content. In response to receiving a trigger operation on the question region option, a plurality of question contents are displayed in the question region. The plurality of question contents include the question content published by the first viewer account.
2. The interaction method based on a live stream interface applied to the online teaching live stream scenario is described as an example.

When a host account (a teacher account) authorizes that an interactive content of a first content type can be published in a first live stream room, a question type is described as an example.

For a terminal of a student account (a viewer account), a live stream interface in the first live stream room is displayed. The first live stream room includes the student account watching a live stream, and the student account includes a first student account master-controlled by the current terminal. An interactive content transmission region and a content type option are displayed. The interactive content transmission region is configured for generating an interactive content published by the first student account in the first live stream room, and the content type option is configured for determining a content type of the interactive content. A generation operation on a first interactive content in the interactive content transmission region is received, and a configuration operation on the question type is received for a question option. The first interactive content published by the first student account is displayed in a display mode corresponding to the question type. For example, a marked question tag is displayed when the first interactive content is displayed.

For a terminal of the teacher account, a host interface in the first live stream room is displayed, the host interface is a display interface corresponding to the teacher account in the first live stream room, and the host account is an account master-controlled by the current terminal. In response to receiving a question content published by the first student account in the first live stream room, the question content is displayed in a display mode corresponding to the question type.

A comment region option and a question region option are displayed in a live stream room comment region of the host interface. The comment region option is configured for displaying all public comments in the first live stream room, and the question region option is configured for displaying the question content. In response to receiving a trigger operation on the question region option, a plurality of question contents are displayed in the question region. The plurality of question contents include the question content published by the first student account.

The above application scenarios are merely illustrative, and are not limited herein.

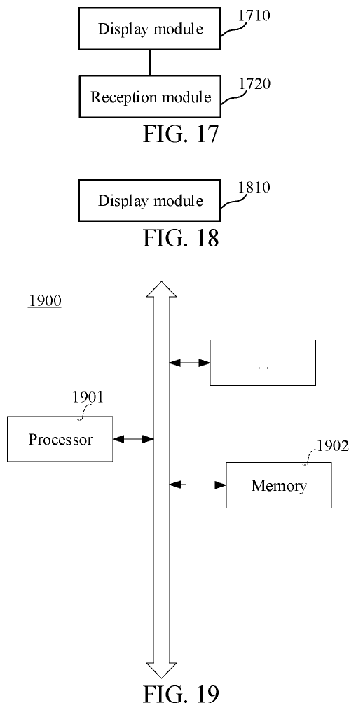

FIG. 17 is a first structural block diagram of an interaction apparatus based on a live stream interface according to an embodiment of this application. As shown in FIG. 17, the apparatus includes the following parts:

a display module 1710 configured to display a live stream interface in a first live stream room, the first live stream room including a viewer account watching a live stream, the viewer account including a first viewer account master-controlled by a current terminal,

the display module 1710 being further configured to display an interactive content transmission region and a content type option, the interactive content transmission region being configured for generating an interactive content published by the first viewer account in the first live stream room, and the content type option being configured for determining a content type of the interactive content; and

a reception module 1720 configured to receive a generation operation on a first interactive content in the interactive content transmission region, and receive a configuration operation on a first content type for a first content type option,

the display module 1710 being further configured to display the first interactive content published by the first viewer account in a display mode corresponding to the first content type.

In some embodiments, the display module 1710 is further configured to display the first interactive content published by the first viewer account in the interactive content display region, the first interactive content being marked with a first type tag corresponding to the first content type; or

display the first interactive content published by the first viewer account in the interactive content display region in a high-brightness display mode corresponding to the first content type.

In some embodiments, the display module 1710 is further configured to display the first interactive content in the interactive content display region in the high-brightness mode through at least one of a background color and a text color that correspond to the first content type; display the first interactive content decorated with a first bounding box in the interactive content display region, display configuration data corresponding to the first bounding box corresponding to the first content type, and the display configuration data being configured for indicating at least one of a color, a size, brightness, a decorative element, and a shape that correspond to the first bounding box; display the first interactive content in the interactive content display region in an enlarged mode; keep the first interactive content displayed in a specified region of the interactive content display region according to preset duration; and display the first interactive content in the interactive content display region according to a preset animation special effect.

In some embodiments, the content type option includes a check control corresponding to the first content type; and the reception module 1720 is further configured to receive a selection operation on the check control corresponding to the first content type, the selection operation being configured for switching the first content type from a deselected state to a selected state.

In some embodiments, the display module 1710 is further configured to display, in response to determining that the first interactive content generated in the interactive content transmission region includes a specified symbol, an automatic switch of the check control corresponding to the first content type from a deselected state to a selected state; or display, in response to determining that the first interactive content generated in the interactive content transmission region includes a specified text content, an automatic switch of the check control corresponding to the first content type from a deselected state to a selected state.

In some embodiments, the reception module 1720 is further configured to receive a trigger operation on the content type option, and display a plurality of candidate content types, the plurality of candidate content types including the first content type; and receive a selection operation on the first content type.

In some embodiments, the first live stream room includes at least one recommended content, the at least one recommended content including a first recommended content; and

the display module 1710 is further configured to display, when the first interactive content published by the first viewer account is displayed, recommended information corresponding to the first recommended content in association with the first interactive content.

In some embodiments, the first recommended content is a primarily-recommended content at a current moment set by a host account in the first live stream room; or the first recommended content is a recommended content associated with the first interactive content and selected by the first viewer account from the at least one recommended content.

In some embodiments, the first recommended content is the recommended content selected by the first viewer account. A live stream image in the live stream interface includes an image content display region corresponding to the at least one recommended content.

The display module 1710 is further configured to take, in response to receiving a selection operation on the image content display region corresponding to the first recommended content in the live stream image, the first recommended content as the recommended content associated with the first interactive content and selected by the first viewer account.

In some embodiments, the display module 1710 is further configured to display, in response to receive a feedback signal from the host account in the first live stream room for the first interactive content, feedback prompt information, the feedback prompt information being configured for prompting the first viewer account to view a feedback content of the host account.

In some embodiments, the feedback prompt information includes at least one of public reply prompt information, independent reply prompt information, and explanation reply prompt information. The public reply prompt information is configured for instructing the host account to reply to the first interactive content in a public interactive content display region. The independent reply prompt information is configured for instructing the host account to reply to the first interactive content through a chat dialog box with the first viewer account. The explanation reply prompt information is configured for instructing the host account to reply to the first interactive content through a live stream image representation in the first live stream room.

In some embodiments, the interactive content display region includes a plurality of interactive contents published by the viewer account in the first live stream room, the plurality of interactive contents including a second interactive content.

The display module 1710 is further configured to keep, in response to receiving the same-question operation by the first viewer account on the second interactive content, the second interactive content displayed in the interactive content display region according to preset duration.

In some embodiments, the first live stream room includes at least one recommended content, the at least one recommended content including a second recommended content and a third recommended content. The second interactive content is associated with the second recommended content, and a display mode of the second interactive content corresponds to a second content type.

The display module 1710 is further configured to automatically copy, in response to receiving the same-question operation, based on the third recommended content, by the first viewer account on the second interactive content, the second interactive content, generate a third interactive content, and publish the third interactive content; and

display, when the third interactive content published by the first viewer account is displayed, recommended information corresponding to the third recommended content in association with the third interactive content, a display mode of the third interactive content corresponding to the second content type.

In conclusion, in the apparatus according to the embodiments of this application, by receiving the configuration operation on the first content type for the first content type option, the viewer can autonomously configure the content type of the interactive content transmitted in the interactive content transmission region. On such a basis, the first interactive content published by the first viewer account is displayed in the display mode corresponding to the first content type, and thus a solution in which the display mode of the interactive content corresponds to the content type is achieved, and the host and the viewer can acquire the content type of the interactive content according to the display mode. Accordingly, when there is a large number of interactive contents, an interactive content of a specific content type can be highlighted. A specific display mode can assist the host in perceiving the interactive content of the specific content type in time, so that the host can give targeted feedback based on the interactive content in time, and interaction efficiency can be improved.

FIG. 18 is a second structural block diagram of an interaction apparatus based on a live stream interface according to an embodiment of this application. As shown in FIG. 18, the apparatus includes the following parts:

a display module 1810 configured to display a host interface in a first live stream room, the host interface being a display interface corresponding to a host account in the first live stream room, and the host account being an account master-controlled by a current terminal.

The display module 1810 is further configured to display, in response to receiving a first interactive content published by a first viewer account in the first live stream room and determining that the first interactive content corresponds to a first content type, the first interactive content published by the first viewer account in a display mode corresponding to the first content type,

the first content type being a content type configured for the first interactive content when the first viewer account generates the first interactive content.

In some embodiments, the display module 1810 is further configured to display a first interactive option and a second interactive option in an interactive content display region, the first interactive option being configured for displaying interactive contents corresponding to a plurality of content types, and the second interactive option being configured for displaying an interactive content corresponding to the first content type; and display, in response to receiving a trigger operation on the second interactive option, a plurality of interactive contents corresponding to the first content type in the interactive content display region, the plurality of interactive contents including the first interactive content.

In conclusion, in the apparatus according to the embodiments of this application, in a case of receiving the first interactive content published by the first viewer account in the first live stream room and determining that the first interactive content corresponds to the first content type, the first interactive content published by the first viewer account is displayed in the display mode corresponding to the first content type, so that a solution in which the display mode of the interactive content corresponds to the content type is achieved, and the host can rapidly determine the content type of the interactive content according to the display mode of the interactive content. Accordingly, when there is a large number of interactive contents, an interactive content of a specific content type can be highlighted. A specific display mode can assist the host in perceiving the interactive content of the specific content type in time, so that the host can give targeted feedback based on the interactive content in time, and interaction efficiency can be improved.

The interaction apparatus based on a live stream interface according to the above embodiment is described with division of the above function modules as an example. In practical applications, the above functions may be allocated to and completed by different function modules according to needs. To be specific, an internal structure of the device is divided into different function modules to complete all or some of the functions described above.

FIG. 19 is a structural block diagram of a terminal 1900 according to an embodiment of this application. The terminal 1900 may be a smartphone, a tablet computer, an MP3 player, an MP4 player, a notebook computer, or a desktop computer. The terminal 1900 may probably be referred to as user equipment, a portable terminal, a laptop terminal, a desktop terminal, etc.

The terminal 1900 typically includes a processor 1901 and a memory 1902.

The processor 1901 may include one or more processing cores, for example, a 4-core processor and an 8-core processor. The processor 1901 may be implemented by using at least one of the following hardware forms: digital signal processing (DSP), a field-programmable gate array (FPGA), and a programmable logic array (PLA). The processor 1901 may alternatively include a main processor and a coprocessor. The main processor is configured to process data in an awakened state, and is also referred to as a central processing unit (CPU). The coprocessor is a low-power processor configured to process data in a standby mode. In some embodiments, the processor 1901 may be integrated with a graphics processing unit (GPU). The GPU is responsible for rendering and drawing a content to be displayed in a display screen. In some embodiments, the processor 1901 may further include an artificial intelligence (AI) processor. The AI processor is configured to process computing operations related to machine learning.

The memory 1902 may include one or more computer-readable storage media. The computer-readable storage medium may be non-transitory. The memory 1902 may further include a high-speed random access memory and a non-volatile memory such as one or more magnetic disk storage devices and a flash memory storage device. In some embodiments, the non-transitory computer-readable storage medium of the memory 1902 is configured to store at least one instruction, the at least one instruction being configured to be executed by the processor 1901 to implement the interaction method based on a live stream interface according to the embodiments of this application.

In some embodiments, the terminal 1900 further includes other components. Those skilled in the art can understand that the structure shown in FIG. 19 does not constitute a limitation to the terminal 1900. The terminal may include more or fewer components than those shown in the figure, or some components may be combined, or a different component layout may be employed.

An electronic device is further provided in the embodiments of this application. The electronic device may be implemented as the terminal or the server shown in FIG. 1. The electronic device includes a processor and a memory, the memory having at least one instruction, at least one program, a code set, or an instruction set stored therein, and the at least one instruction, the at least one program, the code set, or the instruction set being loaded and executed by the processor to implement the interaction method based on a live stream interface according to the method embodiments.

A computer-readable storage medium is further provided in the embodiments of this application. The computer-readable storage medium has at least one instruction, at least one program, a code set, or an instruction set stored therein, the at least one instruction, the at least one program, the code set, or the instruction set being loaded and executed by a processor to implement the interaction method based on a live stream interface according to the method embodiments.

A computer program product or a computer program is further provided in the embodiments of this application. The computer program product or the computer program includes computer instructions, the computer instructions being stored in a computer-readable storage medium. The processor of the electronic device reads the computer instructions from the computer-readable storage medium. The processor executes the computer instructions to cause the electronic device to perform the interaction method based on a live stream interface according to the method embodiments.

In some embodiments, the computer-readable storage medium may include a read only memory (ROM), a random access memory (RAM), a solid state drive (SSD), an optical disk, etc. The random access memory may include a resistance random access memory (ReRAM) and a dynamic random access memory (DRAM). The sequence numbers in the above embodiments of this application are merely for description, but do not indicate the superiority or inferiority of the embodiments.

Those of ordinary skill in the art can understand that all or some of the operations for implementing the above embodiments can be implemented through hardware, or can be implemented by instructing related hardware through a program. The program can be stored in one computer-readable storage medium. The above storage medium can be a read only memory, a magnetic disk, an optical disk, etc.

What are described above are merely the exemplary embodiments of this application, and are not intended to limit this application. Any modification, equivalent substitution, improvement, etc. made within the spirit and principles of this application fall within the scope of protection of this application.

What is claimed is:

1. An interaction method based on a live stream interface performed by an electronic device, the comprising:
displaying a live stream interface in a first live stream room, the first live stream room comprising a viewer account watching a live stream, and the viewer account comprising a first viewer account master-controlled by the electronic device;
displaying, in the live stream interface, an interactive content transmission region and a content type option;
receiving a generation operation on a first interactive content in the interactive content transmission region and a configuration operation on a first content type for a first content type option; and
displaying, in the live stream interface, the first interactive content published by the first viewer account in a display mode corresponding to the first content type.

2. The method according to claim 1, wherein the displaying, in the live stream interface, the first interactive content published by the first viewer account in a display mode corresponding to the first content type comprises:
displaying the first interactive content published by the first viewer account in an interactive content display region, the first interactive content being marked with a first type tag corresponding to the first content type; or
displaying the first interactive content published by the first viewer account in an interactive content display region in a high-brightness display mode corresponding to the first content type.

3. The method according to claim 1, wherein the content type option comprises a check control corresponding to the first content type; and
the receiving a configuration operation on a first content type for a first content type option comprises:
receiving a selection operation on the check control corresponding to the first content type, the selection operation being configured for switching the first content type from a deselected state to a selected state.

4. The method according to claim 1, wherein the receiving a configuration operation on a first content type for a first content type option comprises:
receiving a trigger operation on the content type option, and displaying a plurality of candidate content types, the plurality of candidate content types comprising the first content type; and
receiving a selection operation on the first content type.

5. The method according to claim 1, wherein the first live stream room comprises at least one recommended content, the at least one recommended content comprising a first recommended content; and
the method further comprises:
displaying, when the first interactive content published by the first viewer account is displayed, recommended information corresponding to the first recommended content in association with the first interactive content.

6. The method according to claim 1, wherein after the displaying the first interactive content published by the first viewer account in a display mode corresponding to the first content type, the method further comprises:
displaying, in response to receiving a feedback signal from a host account in the first live stream room for the first interactive content, feedback prompt information, the feedback prompt information being configured for prompting the first viewer account to view a feedback content of the host account.

7. The method according to claim 1, wherein the interactive content display region comprises a plurality of interactive contents published by the viewer account in the first live stream room, the plurality of interactive contents comprising a second interactive content; and
the method further comprises:
keeping, in response to receiving the same-question operation by the first viewer account on the second interactive content, the second interactive content displayed in the interactive content display region according to preset duration.

8. An electronic device, comprising a processor and a memory, the memory having at least one computer program stored therein, and the at least one computer program being loaded and executed by the processor to implement the interaction method based on a live stream interface including:
displaying a live stream interface in a first live stream room, the first live stream room comprising a viewer account watching a live stream, and the viewer account comprising a first viewer account master-controlled by the electronic device;
displaying, in the live stream interface, an interactive content transmission region and a content type option;
receiving a generation operation on a first interactive content in the interactive content transmission region and a configuration operation on a first content type for a first content type option; and
displaying, in the live stream interface, the first interactive content published by the first viewer account in a display mode corresponding to the first content type.

9. The electronic device according to claim 8, wherein the displaying, in the live stream interface, the first interactive content published by the first viewer account in a display mode corresponding to the first content type comprises:
displaying the first interactive content published by the first viewer account in an interactive content display region, the first interactive content being marked with a first type tag corresponding to the first content type; or
displaying the first interactive content published by the first viewer account in an interactive content display region in a high-brightness display mode corresponding to the first content type.

10. The electronic device according to claim 8, wherein the content type option comprises a check control corresponding to the first content type; and
the receiving a configuration operation on a first content type for a first content type option comprises:
receiving a selection operation on the check control corresponding to the first content type, the selection operation being configured for switching the first content type from a deselected state to a selected state.

11. The electronic device according to claim 8, wherein the receiving a configuration operation on a first content type for a first content type option comprises:
receiving a trigger operation on the content type option, and displaying a plurality of candidate content types, the plurality of candidate content types comprising the first content type; and
receiving a selection operation on the first content type.

12. The electronic device according to claim 8, wherein the first live stream room comprises at least one recommended content, the at least one recommended content comprising a first recommended content; and
the method further comprises:
displaying, when the first interactive content published by the first viewer account is displayed, recommended information corresponding to the first recommended content in association with the first interactive content.

13. The electronic device according to claim 8, wherein after the displaying the first interactive content published by the first viewer account in a display mode corresponding to the first content type, the method further comprises:
displaying, in response to receiving a feedback signal from a host account in the first live stream room for the first interactive content, feedback prompt information, the feedback prompt information being configured for prompting the first viewer account to view a feedback content of the host account.

14. The electronic device according to claim 8, wherein the interactive content display region comprises a plurality of interactive contents published by the viewer account in the first live stream room, the plurality of interactive contents comprising a second interactive content; and
the method further comprises:
keeping, in response to receiving the same-question operation by the first viewer account on the second interactive content, the second interactive content displayed in the interactive content display region according to preset duration.

15. A non-transitory computer-readable storage medium having at least one computer program stored therein, the at least one computer program, when loaded and executed by a processor of a computer device, causing the computer device to implement an interaction method based on a live stream interface including:
displaying a live stream interface in a first live stream room, the first live stream room comprising a viewer account watching a live stream, and the viewer account comprising a first viewer account master-controlled by the electronic device;
displaying, in the live stream interface, an interactive content transmission region and a content type option;
receiving a generation operation on a first interactive content in the interactive content transmission region and a configuration operation on a first content type for a first content type option; and
displaying, in the live stream interface, the first interactive content published by the first viewer account in a display mode corresponding to the first content type.

16. The non-transitory computer-readable storage medium according to claim 15, wherein the displaying, in the live stream interface, the first interactive content published by the first viewer account in a display mode corresponding to the first content type comprises:
displaying the first interactive content published by the first viewer account in an interactive content display region, the first interactive content being marked with a first type tag corresponding to the first content type; or
displaying the first interactive content published by the first viewer account in an interactive content display region in a high-brightness display mode corresponding to the first content type.

17. The non-transitory computer-readable storage medium according to claim 15, wherein the content type option comprises a check control corresponding to the first content type; and
the receiving a configuration operation on a first content type for a first content type option comprises:
receiving a selection operation on the check control corresponding to the first content type, the selection operation being configured for switching the first content type from a deselected state to a selected state.

18. The non-transitory computer-readable storage medium according to claim 15, wherein the receiving a configuration operation on a first content type for a first content type option comprises:
receiving a trigger operation on the content type option, and displaying a plurality of candidate content types, the plurality of candidate content types comprising the first content type; and
receiving a selection operation on the first content type.

19. The non-transitory computer-readable storage medium according to claim 15, wherein the first live stream room comprises at least one recommended content, the at least one recommended content comprising a first recommended content; and
the method further comprises:
displaying, when the first interactive content published by the first viewer account is displayed, recommended information corresponding to the first recommended content in association with the first interactive content.

20. The non-transitory computer-readable storage medium according to claim 15, wherein after the displaying the first interactive content published by the first viewer account in a display mode corresponding to the first content type, the method further comprises:
displaying, in response to receiving a feedback signal from a host account in the first live stream room for the first interactive content, feedback prompt information, the feedback prompt information being configured for prompting the first viewer account to view a feedback content of the host account.
